(19) United States
(12) Patent Application Publication
(10) Pub. No.: US 2026/0025257 A1
(43) Pub. Date: Jan. 22, 2026

(54) Secured Frame in Ultra-Wideband

(71) Applicant: Huawei Technologies Co., Ltd., Shenzhen (CN)

(72) Inventors: Rojan Chitrakar, Singapore (SG); Lei Huang, Singapore (SG); Kuan Wu, Shenzhen (CN); Yunbo Li, Shenzhen (CN); Xun Yang, Singapore (SG)

(73) Assignee: Huawei Technologies Co., Ltd., Shenzhen (CN)

(21) Appl. No.: 19/347,079

(22) Filed: Oct. 1, 2025

Related U.S. Application Data
(63) Continuation of application No. PCT/CN2023/086009, filed on Apr. 3, 2023.

(51) Int. Cl. H04L 7/00

(52) U.S. Cl. CPC H04L 7/0004; H04L 7/0079

(57) ABSTRACT

A method includes that a first secured frame to be transmitted in a slot in a first round belonging to a first block based on a block-based time structure or a hyper block-based time structure may be generated, where the block-based time structure or the hyper block-based time structure comprises a plurality of blocks, each block of the plurality of blocks comprises a plurality of rounds, each round of the plurality of rounds comprises a plurality of slots, the first secured frame is secured by a first nonce being constructed based on identifying information associated with the first secured frame, a round index and a block index, the round index is an index of the first round, and the block index is an index of the first block.

### CROSS-REFERENCE TO RELATED APPLICATIONS

This is a continuation of International Patent Application No. PCT/CN2023/086009 filed on Apr. 3, 2023, the disclosure of which is hereby incorporated by reference in its entirety.

### TECHNICAL FIELD

Example embodiments of the present disclosure generally relate to the field of telecommunication and in particular, to methods, devices, apparatuses, and a computer readable storage medium for communication.

### BACKGROUND

One of main objectives of enhancement is increasing an accuracy of ranging measurement in Institute of Electrical and Electronic Engineers (IEEE) 802.15.4z. A block-based time structure or a hyper block-based time structure can be used in ranging.

An authenticated encryption with associated data (AEAD) security operation is proposed in ranging. One important input for the AEAD security operation is a unique nonce. However, how to construct the nonce is still needed to be further studied.

### SUMMARY

In general, example embodiments of the present disclosure provide a solution for secured frame in ultra-wideband.

In a first aspect, there is provided a method, comprising generating, a first secured frame to be transmitted in a slot in a first round belonging to a first block based on a block-based time structure or a hyper block-based time structure, wherein the block-based time structure or the hyper block-based time structure comprises a plurality of blocks, each block of the plurality of blocks comprises a plurality of rounds, each round of the plurality of rounds comprises a plurality of slots, wherein the first secured frame is secured by a first nonce being constructed based on identifying information associated with the first secured frame, a round index and a block index, the round index is an index of the first round, and the block index is an index of the first block; and transmitting the first secured frame. As such, the security operation may be performed and the communication can be guaranteed to be secured.

In some examples, the identifying information comprises a slot index, and the slot index is an index of the slot which the first secured frame is transmitted in. Since the first secured frame is transmitted in a specific slot, the first nonce can be used for securing the first secured frame.

In some examples, the first nonce comprises a first field with a first quantity of bits carrying the slot index. In some examples, the first quantity is determined based on a quantity of the plurality of slots in each round, or the first quantity is a first predefined quantity. In case the first quantity may be predefined, the agreement between the transmitter and the receiver can be simplified. In case the first quantity is a variable, there may be some rest bits in the first nonce which can be used for other information.

In some examples, the identifying information comprises a first packet number (PN), and wherein the first PN is a packet number of the first secured frame. Since the first PN is specific to the first secured frame, the first nonce can be used for securing the first secured frame.

In some examples, the first nonce comprises a first field with a first quantity of bits carrying the first PN. In some examples, the first quantity is a first predefined quantity.

In some examples, the first nonce comprises a second field with a second quantity of bits carrying the round index, and a third field with a third quantity of bits carrying the block index.

In some examples, the second quantity is determined based on a quantity of the plurality of rounds in each block, or the second quantity is a second predefined quantity. In some examples, the third quantity is a third predefined quantity.

In some examples, a sum of the first quantity, the second quantity, and the third quantity equals to a predefined total quantity.

As such, the first nonce can be constructed by comprising the identifying information, the round index, and the block index. Accordingly, the first nonce can be used for securing the first secured frame.

In some examples, the first nonce comprises a fourth field with a fourth quantity of bits carrying a cycle index, wherein the cycle index is an index of a cycle which comprises a plurality of blocks with the first block in. As such, a cycle index can be further used to construct the first nonce, and accordingly a security key may be used for a longer time.

In some examples, the first nonce comprises a first block indicator indicating that the first secured frame is transmitted based on the block-based time structure or the hyper block-based time structure.

In some examples, the first secured frame comprises the block index and the round index. As such, the first secured frame may include the block index and the round index, thus the receiver may correctly construct a nonce for unsecuring.

In some examples, the first secured frame comprises a first block index presence indicator indicating a presence of the first block index, and a first round index presence indicator indicating a presence of the first round index. In case the block index or the round index is a default value, the block index or the round index may not be transmitted, and thus signaling overhead can be reduced.

In some examples, the first secured frame comprises a first security indicator indicating that the first secured frame is secured. Therefore, whether a frame is secured may be determined based on a security indicator.

In some examples, the method further comprises generating a second secured frame to be transmitted, wherein the second secured frame is secured by a second nonce being constructed based on a second PN, wherein the second PN is a packet number of the second secured frame; and transmitting the second secured frame. As such, a PN may be used for constructing a nonce for a frame which is not based on a block-based time structure or a hyper block-based time structure.

In some examples, the second nonce comprises a field with a predefined quantity of octets carrying the second PN.

In some examples, the second nonce comprises a second block indicator indicating that the second secured frame is transmitted outside the block-based time structure or the hyper block-based time structure.

In some examples, the second secured frame comprises a PN field carrying the second PN.

In some examples, the second secured frame comprises a second security indicator indicating that the second secured frame is secured.

In some examples, the second secured frame comprises a secured payload, and wherein the secured payload comprises a second block index presence indicator indicating whether a second block index is comprised, a second round index presence indicator indicating whether a second round index is comprised, and a second slot index presence indicator indicating whether a second slot index is comprised.

In some examples, the secured payload comprises the block index if the second block index presence indicator indicates that the second block index is comprised, the round index if the second round index presence indicator indicates that the second round index is comprised, and the slot index if the second slot index presence indicator indicates that the second slot index is comprised.

In some examples, at least one of the second block index presence indicator, the second round index presence indicator, or the second slot index presence indicator indicates that a corresponding index is not comprised, and implicitly indicates that the corresponding index is a default index.

In a second aspect, there is provided a method, comprising receiving a first secured frame transmitted in a slot in a first round belonging to a first block based on a block-based time structure or a hyper block-based time structure, wherein the block-based time structure or the hyper block-based time structure comprises a plurality of blocks, each block of the plurality of blocks comprises a plurality of rounds, each round of the plurality of rounds comprises a plurality of slots; and unsecuring the first secured frame based on a first nonce, wherein the first nonce is constructed based on identifying information associated with the first secured frame, a round index and a block index, wherein the round index is an index of the first round, and the block index is an index of the first block.

In some examples, the identifying information comprises a slot index, and the slot index is an index of the slot which the first secured frame is transmitted in.

In some examples, the first nonce comprises a first field with a first quantity of bits carrying the slot index. In some examples, the first quantity is determined based on a quantity of the plurality of slots in each round, or the first quantity is a first predefined quantity.

In some examples, the identifying information comprises a first packet number (PN), and wherein the first PN is a packet number of the first secured frame. In some examples, the first nonce comprises a first field with a first quantity of bits carrying the first PN. In some examples, the first quantity is a first predefined quantity.

In some examples, the first nonce comprises a second field with a second quantity of bits carrying the round index, and a third field with a third quantity of bits carrying the block index.

In some examples, the second quantity is determined based on a quantity of the plurality of rounds in each block, or the second quantity is a second predefined quantity. In some examples, the third quantity is a third predefined quantity.

In some examples, a sum of the first quantity, the second quantity, and the third quantity equals to a predefined total quantity.

In some examples, the first nonce comprises a fourth field with a fourth quantity of bits carrying a cycle index, wherein the cycle index is an index of a cycle which comprises a plurality of blocks with the first block in.

In some examples, the first nonce comprises a first block indicator indicating that the first secured frame is in transmitted based on the block-based time structure or the hyper block-based time structure.

In some examples, the first secured frame comprises the block index and carrying the round index.

In some examples, the first secured frame comprises a first block index presence indicator indicating a presence of the first block index, and a first round index presence indicator indicating a presence of the first round index.

In some examples, the first secured frame comprises a first security indicator indicating that the first secured frame is secured.

In some examples, the method further comprises receiving a second secured frame transmitted not based on the block-based time structure or the hyper block-based time structure; and unsecuring the second secured frame based on a second nonce being constructed based on a second PN, wherein the second PN is a packet number of the second secured frame.

In some examples, the second nonce comprises a field with a predefined quantity of octets carrying the second PN.

In some examples, the second nonce comprises a second block indicator indicating that the second frame is transmitted outside the block-based time structure or the hyper block-based time structure.

In some examples, the second secured frame comprises a PN field carrying the second PN.

In some examples, the second secured frame comprises a second security indicator indicating that the second secured frame is secured.

In some examples, the second secured frame comprises a secured payload, wherein unsecuring the second secured frame comprises unsecuring the secured payload based on the second nonce, and wherein the secured payload comprises a second block index presence indicator indicating whether a second block index is comprised, a second round index presence indicator indicating whether a second round index is comprised, and a second slot index presence indicator indicating whether a second slot index is comprised.

In some examples, the secured payload comprises the block index if the second block index presence indicator indicates that the second block index is comprised, the round index if the second round index presence indicator indicates that the second round index is comprised, and the slot index if the second slot index presence indicator indicates that the second slot index is comprised.

In some examples, the method further comprises: in accordance with a determination that at least one of the second block index presence indicator, the second round index presence indicator, or the second slot index presence indicator indicates that a corresponding index is not comprised, determining that the corresponding index is a default index.

In a third aspect, there is provided an apparatus, comprising a generating module configured to generate a first secured frame to be transmitted in a slot in a first round belonging to a first block based on a block-based time structure or a hyper block-based time structure, wherein the block-based time structure or the hyper block-based time structure comprises a plurality of blocks, each block of the plurality of blocks comprises a plurality of rounds, each round of the plurality of rounds comprises a plurality of slots, wherein the first secured frame is secured by a first nonce being constructed based on identifying information associated with the first secured frame, a round index and a block index, the round index is an index of the first round, and the block index is an index of the first block; and a transmitting module configured to transmit the first secured frame.

The apparatus may comprise respective modules for implementing the methods in the first aspect, for ease of brevity, the detailed description will not be listed herein.

In a fourth aspect, there is provided an apparatus comprising a receiving module configured to receive a first secured frame transmitted in a slot in a first round belonging to a first block based on a block-based time structure or a hyper block-based time structure, wherein the block-based time structure or the hyper block-based time structure comprises a plurality of blocks, each block of the plurality of blocks comprises a plurality of rounds, each round of the plurality of rounds comprises a plurality of slots; and an unsecuring module configured to unsecure the first secured frame based on a first nonce, wherein the first nonce is constructed based on identifying information associated with the first secured frame, a round index and a block index, wherein the round index is an index of the first round, and the block index is an index of the first block.

The apparatus may comprise respective modules for implementing the methods in the first aspect, for ease of brevity, the detailed description will not be listed herein.

In a fifth aspect, there is provided a method, comprising generating a first secured frame to be transmitted in a block-based time structure or a hyper block-based time structure, wherein the first secured frame is secured by a first nonce being constructed based on a first base PN (BPN) and a first PN, the first BPN is associated with an initiator and a responder, and the first PN is a packet number of the first secured frame; and transmitting the first secured frame.

In some examples, the first secured frame comprises a first security indicator indicating that the first secured frame is secured.

In some examples, the first nonce comprises a first field with a first quantity of bits carrying the first BPN, and a second field with a second quantity of bits carrying the first PN.

In some examples, the first secured frame comprises a first PN field carrying the first PN.

In some examples, the first secured frame indicates the first BPN.

In some examples, the first secured frame comprises a BPN presence field carrying a BPN presence indicator indicating whether a BPN field is comprised.

In some examples, the first secured frame comprises the BPN field carrying the first BPN if the BPN presence indicator indicates that the BPN field is comprised.

In some examples, the first secured frame indicates that the first BPN is a default number if the BPN presence indicator indicates that the BPN field is not comprised.

In some examples, the method further comprises storing the first BPN associated with a first communication direction between the initiator and the responder.

In some examples, the method further comprises transmitting a second secured frame comprising a second PN which is less than a PN comprised in a previous frame of the third secured frame.

In some examples, the method further comprises transmitting a third secured frame comprising a second BPN.

In a sixth aspect, there is provided a method, comprising receiving a first secured frame transmitted in the block-based time structure or the hyper block-based time structure; and unsecuring the first secured frame based on a first nonce, wherein the first nonce is constructed based on a first BPN and a first PN, the first BPN is associated with an initiator and a responder, and the first PN is a packet number of the first secured frame.

In some examples, the first secured frame comprises a first security indicator indicating that the first secured frame is secured.

In some examples, the first nonce comprises a first field with a first quantity of bits carrying the first BPN, and a second field with a second quantity of bits carrying the first PN.

In some examples, the first secured frame comprises a first PN field carrying the first PN. In some examples, the first secured frame indicates the first BPN.

In some examples, the first secured frame comprises a BPN presence field carrying a BPN presence indicator indicating whether a BPN field is comprised.

In some examples, the first secured frame comprises the BPN field carrying the first BPN if the BPN presence indicator indicates that the BPN field is comprised.

In some examples, the first secured frame indicates that the first BPN is a default number if the BPN presence indicator indicates that the BPN field is not comprised.

In some examples, the method further comprises storing the first BPN associated with a first communication direction between the initiator and the responder.

In some examples, the method further comprises receiving a second secured frame comprising a second PN; and in accordance with a determination that the second PN is less than a PN comprised in a previous frame of the third secured frame, updating the first BPN by incrementing by one.

In some examples, the method further comprises receiving a third secured frame comprising a second BPN; and replacing the first BPN by the second BPN.

In a seventh aspect, there is provided an apparatus comprising a generating module configured to generate a first secured frame to be transmitted in a block-based time structure or a hyper block-based time structure, wherein the first secured frame is secured by a first nonce being constructed based on a first BPN and a first PN, the first BPN is associated with an initiator and a responder, and the first PN is a packet number of the first secured frame; and a transmitting module configured to transmit the first secured frame.

The apparatus may comprise respective modules for implementing the methods in the fifth aspect, for ease of brevity, the detailed description will not be listed herein.

In an eighth aspect, there is provided an apparatus comprising a receiving module configured to receive a first secured frame transmitted in the block-based time structure or the hyper block-based time structure; and an unsecuring module configured to unsecure the first secured frame based on a first nonce, wherein the first nonce is constructed based on a first BPN and a first PN, the first BPN is associated with an initiator and a responder, and the first PN is a packet number of the first secured frame.

The apparatus may comprise respective modules for implementing the methods in the sixth aspect, for ease of brevity, the detailed description will not be listed herein.

In a ninth aspect, there is provided a communication device, comprising a processor configured to perform, with a transceiver, at least the method in the first, second, fifth, or sixth aspect.

In a tenth aspect, there is provided a system, comprising an apparatus in the third aspect and an apparatus in the fourth aspect.

In an eleventh aspect, there is provided a system, comprising an apparatus in the seventh aspect and an apparatus in the eighth aspect.

In a twelfth aspect, there is provided a non-transitory computer readable medium comprising program instructions for causing an apparatus to perform at least the method in the first, second, fifth, or sixth aspect.

In a thirteenth aspect, there is provided a computer program comprising instructions, which, when executed by an apparatus, cause the apparatus at least to perform the method in the first, second, fifth, or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings.

FIG. 1A illustrates a schematic diagram of a block-based time structure;

FIG. 1B illustrates a schematic diagram of a hyper block-based time structure;

FIG. 1C illustrates a schematic diagram of a multi-millisecond (MMS) ranging session;

FIG. 1D illustrates a schematic diagram of a format of a compressed physical layer (PHY) service data unit (PSDU);

FIG. 1E illustrates a schematic diagram of a format of a compressed header IE-only frame;

FIG. 1F illustrates a schematic diagram of a format of a nonce;

FIG. 2A illustrates an example communication system in which some embodiments of the present disclosure can be implemented;

FIG. 2B illustrates another example communication system in which some embodiments of the present disclosure can be implemented;

FIG. 3 illustrates a signaling chart illustrating communication process in accordance with some example embodiments of the present disclosure;

FIG. 4 illustrates a schematic diagram of an example narrowband-assisted (NBA)-MMS ranging session in a block-based time structure in accordance with some example embodiments of the present disclosure;

FIG. 5 illustrates a signaling chart illustrating a process of an example MMS ranging session in accordance with some example embodiments of the present disclosure;

FIG. 6A illustrates a schematic diagram of a format of a start of ranging (SOR) frame in accordance with some example embodiments of the present disclosure;

FIG. 6B illustrates a schematic diagram of a format of a nonce for securing a frame transmitted in an outside block structure in accordance with some example embodiments of the present disclosure;

FIG. 7A illustrates a schematic diagram of a format of a POLL frame in accordance with some example embodiments of the present disclosure;

FIG. 7B illustrates a schematic diagram of a format of a nonce for securing a frame inside block structure in accordance with some example embodiments of the present disclosure;

FIG. 7C illustrates an example of constructing the nonce for securing a compressed frame in accordance with some example embodiments of the present disclosure;

FIG. 8 illustrates a schematic diagram of another format of a nonce for securing a frame inside block structure in accordance with some example embodiments of the present disclosure;

FIG. 9 illustrates a schematic diagram of a format of a secured SOR frame in accordance with some example embodiments of the present disclosure;

FIG. 10A illustrate an example session of the initiator with a responder 1 in accordance with some example embodiments of the present disclosure;

FIG. 10B illustrate an example session of the initiator with a responder 2 in accordance with some example embodiments of the present disclosure;

FIG. 11A illustrates a schematic diagram of a time structure including a cycle in accordance with some example embodiments of the present disclosure;

FIG. 11B illustrates a schematic diagram of a format of another secured SOR frame in accordance with some example embodiments of the present disclosure;

FIG. 11C illustrates a schematic diagram of another format of a nonce for securing a frame inside block structure in accordance with some example embodiments of the present disclosure;

FIG. 12A illustrates a schematic diagram of a nonce construction in a hyper block-based time structure in accordance with some example embodiments of the present disclosure;

FIG. 12B illustrates a schematic diagram of a nonce construction in a hyper block-based time structure in accordance with some example embodiments of the present disclosure;

FIG. 13 illustrates a schematic diagram of another example MMS ranging session in a block-based time structure in accordance with some example embodiments of the present disclosure;

FIG. 14 illustrates a signaling chart illustrating a process of another example MMS ranging session in accordance with some example embodiments of the present disclosure;

FIG. 15A illustrates a schematic diagram of a format of a nonce for securing a frame in accordance with some example embodiments of the present disclosure;

FIG. 15B illustrates a schematic diagram of another format of nonce for securing a frame in accordance with some example embodiments of the present disclosure;

FIG. 16A illustrates a schematic diagram of a format of a secured ranging packet report (RPRT) frame in accordance with some example embodiments of the present disclosure;

FIG. 16B illustrates a schematic diagram of a format of an advertising poll (ADV-POLL) frame in accordance with some example embodiments of the present disclosure;

FIG. 17 illustrates an example session of the initiator with a responder 1 and a responder 2 in accordance with some example embodiments of the present disclosure;

FIG. 18 illustrates a signaling chart illustrating communication process in accordance with some example embodiments of the present disclosure;

FIG. 19 illustrates a schematic diagram of an example MMS ranging session in accordance with some example embodiments of the present disclosure;

FIG. 20 illustrates a signaling chart illustrating a process of an example MMS ranging session in accordance with some example embodiments of the present disclosure;

FIG. 21A illustrates a schematic diagram of a format of a secured frame during an initialization and setup phase in accordance with some example embodiments of the present disclosure;

FIG. 21B illustrates a schematic diagram of a format of a secured frame during a measurement cycle in accordance with some example embodiments of the present disclosure;

FIG. 21C illustrates a schematic diagram of a format of a secured SOR frame in accordance with some example embodiments of the present disclosure;

FIG. 21D illustrates a schematic diagram of a format of a secured peer management request (PRM-REQ) or peer management response (PRM-RESP) frame in accordance with some example embodiments of the present disclosure;

FIG. 21E illustrates a schematic diagram of a format of a nonce in accordance with some example embodiments of the present disclosure;

FIG. 22A illustrates an example downlink session from the initiator to a responder 1 in accordance with some example embodiments of the present disclosure;

FIG. 22B illustrates an example uplink session from a responder 2 to the initiator in accordance with some example embodiments of the present disclosure;

FIG. 23 illustrates an example block diagram of a communication apparatus in accordance with some embodiments of the present disclosure;

FIG. 24 illustrates an example block diagram of another communication apparatus in accordance with some embodiments of the present disclosure; and

FIG. 25 illustrates an example block diagram of a device that may be used to implement some embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

Ultra-wideband (UWB) technology has being used for indoor positioning and other location services such as access control and asset locating. Aside from dedicated devices and tags, UWB radios are becoming increasingly common in high end smartphones. A work group on an enhancement of the UWB technology is ongoing.

UWB technology has been used in a variety of use cases, such as device free sensing, downlink time difference of arrival (DL-TDOA), long range ranging etc. MMS ranging has been introduced to address the long-range ranging use case. The key idea behind MMS ranging is to distribute UWB ranging frames into multiple fragments, where each fragment is transmitted across multiple milliseconds (ms), thereby overcoming the emitted energy limit of 37 nanojoules (nJ)/ms. A NBA MMS ranging, which can be regarded as an enhancement of the MMS ranging, is proposed by high-performance narrowband (NB) radio which is used for providing time synchronization for the UWB radio and for controlling signaling. In MMS ranging, the number of fragments required for the ranging depends on a range to be measured as well as channel conditions, and thus may be dynamically adjusted even within the same ranging session.

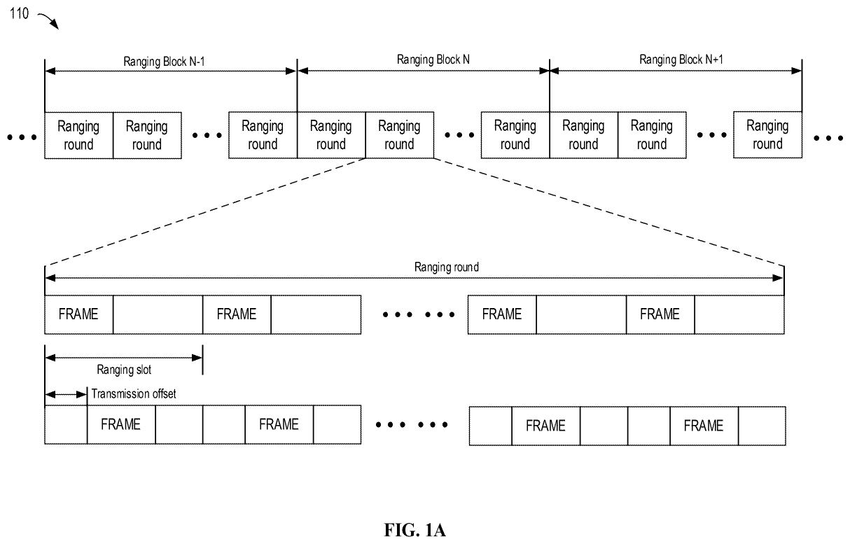

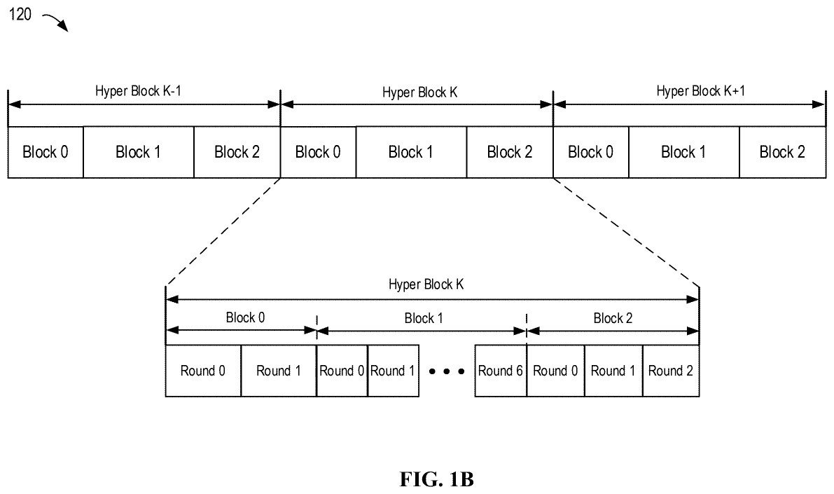

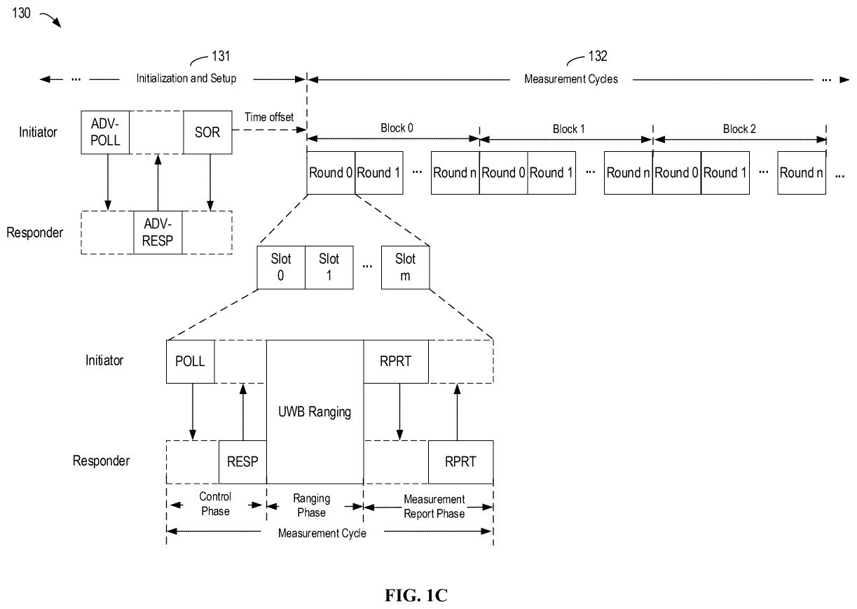

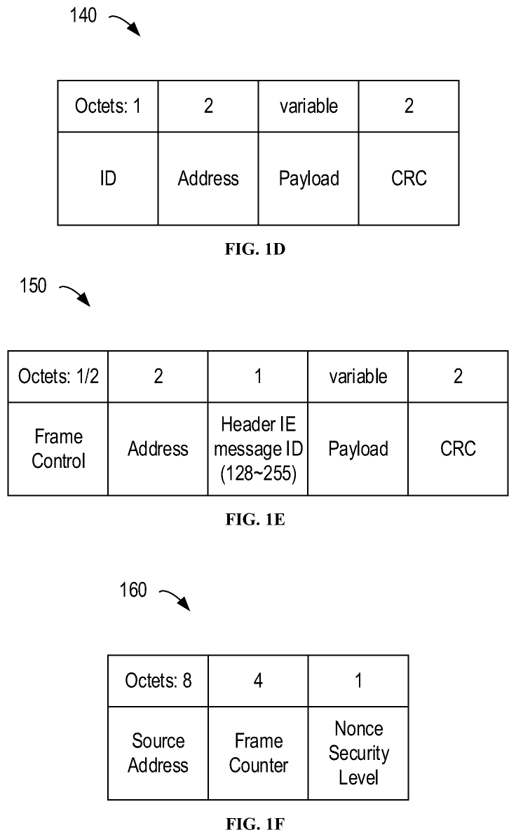

FIG. 1A illustrates a schematic diagram of a block-based time structure 110. As shown in FIG. 1A, each block includes multiple rounds, and each round includes multiple slots. The block-based time structure 110 may be used for block-based mode of ranging. The block-based mode may use a structured timeline where the block-based time structure 110 is periodic by default. In some examples, a block may also be referred to as a ranging block, a round may also be referred to as a ranging round, and a slot may also be referred to as a ranging slot.

The ranging round is a time period of sufficient duration to complete one entire range-measurement cycle involving the set of enhanced ranging devices (ERDEVs) participating in the ranging exchange. The ranging slot is a time period of sufficient duration for a transmission of at least one frame. As shown in FIG. 1A, a start of a frame may be aligned with a start of a slot, or a transmission offset may be applied from a start of a slot to a start of a frame.

The block-based time structure 110 may be determined beforehand and remain unchanged during a ranging session. It is to be understood that the block-based time structure 110 may not be well suited for the NBA-MMS ranging use case, in which a round duration may change dynamically.

FIG. 1B illustrates a schematic diagram of a hyper block-based time structure 120. As shown in FIG. 1B, each hyper block includes multiple blocks. Different blocks in a hyper block may have different configurations, such as a block duration, a round duration, a slot duration, quantity of rounds in a block, quantity of slots in a round. For example, the hyper block K in FIG. 1B includes block 0, block 1, and block 2, where block 0 includes 2 rounds, block 1 includes 7 rounds, and block 2 includes 3 rounds.

In some examples, different blocks in a hyper block may be used for different uses. For example, block 0 may be used for DL-TDOA, block 1 may be used for ranging, and block 2 may be used for sensing. In some other examples, different blocks in a hyper block may be used for different scenarios in a same use. For example, block 0, block 1, and block 2 are all used for NBA-MMS ranging, but block 1 may be used for one-to-one ranging in good channel condition, block 0 may be used for one-to-many ranging and block 2 may be used for one-to-one ranging in bad channel condition etc.

FIG. 1C illustrates a schematic diagram of an MMS ranging session 130. The MMS ranging session 130 includes an initialization and setup phase 131 and one or more measurement cycles 132. The MMS ranging session 130 involves an initiator and a responder. It is to be understood that the initiator may be a device initiating a UWB exchange by transmitting the first message, while the responder may be a device receiving and responding the first message from the initiator.

In some examples, the frames are transmitted in an initialization channel during the initialization and setup phase 131, and the frames are transmitted in a ranging channel during the one or more measurement cycles 132. In some examples, a same channel may be used as both the initialization channel and the ranging channel, e.g., a well-known channel may be used.

During the initialization and setup phase 131, the initiator and the responder may negotiate a ranging configuration. Further, the initiator transmits an ADV-POLL frame opportunistically at times and intervals to its discretion, the responder may opportunistically listen for incoming ADV-POLL frame and respond with an advertising response (ADV-RESP) frame if the responder intends to participate in a ranging session with the initiator. Once the initiator has received the ADV-RESP frame, it transmits a SOR frame that provides a time offset at which the first measurement cycle will start.

A measurement cycle, also referred to as a range-measurement cycle, includes a control phase, a ranging phase, and an optional measurement report phase. The control phase (or also called as a ranging control phase) starts at a beginning of a range-measurement cycle. The initiator starts the ranging control phase by transmitting a POLL frame to the responder at the beginning of the first ranging slot of a ranging round. The responder that receives the POLL frame successfully transmits a RESP frame back to the initiator. The POLL and RESP frames allow the initiator and the responder to achieve a time and frequency synchronization. In some examples, other control information may also be included in the POLL frame.

In the ranging phase, the initiator and the responder may exchange zero or more UWB ranging sequence fragments (RSFs) and optionally one or more UWB ranging integrity fragments (RIFs). The RSFs are used to perform ranging measurements while the RIFs are used to check the integrity of the ranging measurements.

The measurement report phase may start after the initiator or the responder completes the reception of all UWB fragments for the ranging phase. In the measurement report phase, the initiator or the responder may generate a ranging measurement report, and transmit a RPRT frame carrying the measurement report to the peer device.

The frames in the control phase and the frames in the ranging phase are transmitted using UWB for MMS ranging. The frames in the control phase are transmitted using NB and the frames in the ranging phase are transmitted using UWB for NBA-MMS ranging.

In order to provide more space for carried information in the frames, a compressed (PSDU is introduced. FIG. 1D illustrates a schematic diagram of a format of a compressed PSDU 140. The compressed PSDU 140 can be used for NB control frames. As shown in FIG. 1D, the compressed PSDU 140 includes an identifier (ID) field with 1 octet, an address field with 2 octets, a payload field with a variable length, and a cyclic redundancy check (CRC) field with 2 octets.

Similarly, a compressed header information element (IE) only frame is also introduced. FIG. 1E illustrates a schematic diagram of a format of a compressed header IE-only frame 150. The compressed header IE-only frame 150 can be used for broadcast traffic. As shown in FIG. 1E, the compressed header IE-only frame 150 includes a frame control field with 1 or 2 octets, an address field with 2 octets, a header IE message ID field with 1 octet, a payload field with a variable length, and a CRC field with 2 octets.

Either the compressed PSDU 140 or the compressed header IE-only frame 150 may be carried in an 802.15.4ab physical protocol data unit (PPDU). It is also possible that a 802.15.4 frame carried in an 802.15.4ab PPDU may be used for MMS ranging and the frame may not carry the auxiliary security header field (and hence does not carry the frame counter field).

As mentioned above, an AEAD security operation is proposed. The AEAD security operation uses an extension of counter mode encryption and cipher block chaining message authentication code. Aside from a security key, an important input for every AEAD security operation is a unique Nonce. FIG. 1F illustrates a schematic diagram of a format of a nonce 160. The nonce 160 can be used for a non-time slotted channel hopping (TSCH) mode. As shown in FIG. 1F, the nonce 160 includes a source address field with 8 octets, a frame counter field with 4 octets, and a nonce security level field with 1 octet.

In case an AEAD security operation is applied to a compressed PSDU or a compressed header IE-only frame, or an 802.15.4 frame that does not carry the frame counter field, how to construct the nonce should be further studied.

Embodiments of the present disclosure provide a solution for a secured frame in ultra-wideband. In some embodiments, a secured frame may be generated based on a nonce, where the nonce is constructed based on identifying information associated with the secured frame, a block index and a round index associated with a round and a block which the first secured frame transmitted in. As such, the security operation may be performed and the communication can be guaranteed to be secured. Principles and implementations of the present disclosure will be described in detail below with reference to the figures.

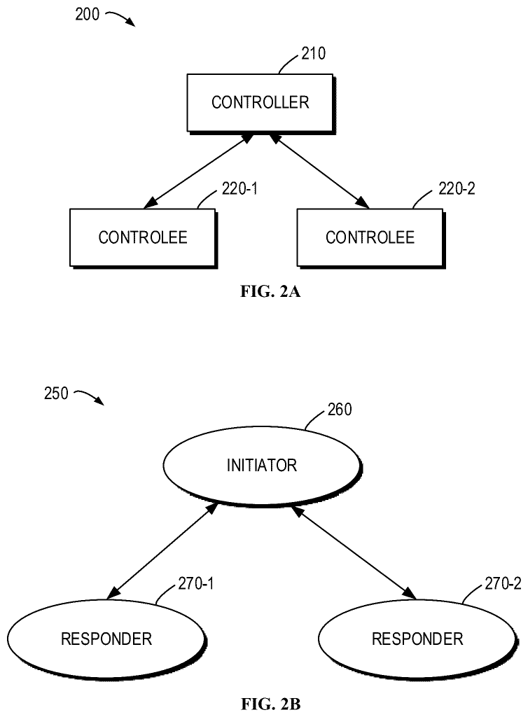

FIG. 2A illustrates an example communication system 200 in which some embodiments of the present disclosure can be implemented. The communication system 200 includes a controller 210, a controlee 220-1, and a controlee 220-2, where the controlees 220-1 and 220-2 can be collectively or separately referred to as a controlee 220.

In the present disclosure, the controller 210 may be device that controls the UWB session and defines the session parameters, and the controlee 220 may be a device that utilizes the session parameters received from the controller 210 to participate in the UWB session.

The UWB session may also be called as a UWB exchange. While participating the UWB session, the controller 210 may be an initiator and the controlee 220 may be a responder, or the controlee 220 may be an initiator and the controller 210 may be a responder.

FIG. 2B illustrates another example communication system 250 in which some embodiments of the present disclosure can be implemented. The communication system 250 includes an initiator 260, a responder 270-1, and a responder 270-2, where the responders 270-1 and 270-2 can be collectively or separately referred to as a responder 270.

In the present disclosure, the initiator 260 may be a device following the instruction(s) from a controller, the initiator 260 may initiates a UWB exchange by sending the first message of the exchange to the responder 270. The responder 270 may be a device that responds to the first message received from the initiator 260 and participates in the UWB exchange.

In the system 250, a link from the initiator 260 to the responder 270 is referred to as a downlink (DL), while a link from the responder 270 to the initiator 260 is referred to as an uplink (UL). In downlink, the initiator 260 is a transmitting (TX) device (or a transmitter) and the responder 270 is a receiving (RX) device (or a receiver). In uplink, the responder 270 is a transmitting TX device (or a transmitter) and the initiator 260 is a RX device (or a receiver).

It is to be understood that a controller or a controlee can be the initiator 260; similarly a controlee or a controller can be the responder 270. As a specific example, the initiator 260 is the controller 210, the responder 270-1 is the controlee 220-1, and the responder 270-2 is the controlee 220-2. However, it should be understood that this is only for ease of illustration without any limitation of the protection scope.

The device in the present disclosure, such as the controller 210 or the controlee 220 in FIG. 2A or the initiator 260 or the responder 270 in FIG. 2B, can be implemented as a tag, a mobile device, a key fob, a vehicle, a door lock, or the like, where the mobile device may include but not limited to a smart phone, a personal digital assistant (PDA), a laptop, a tablet, a wearable device, an internet of things (IOT) device, a vehicle-to-everything (V2X) device, etc.

It is to be understood that the numbers of devices and their connection relationships and types shown in FIG. 2A and FIG. 2B are only for the purpose of illustration without suggesting any limitation. The system 200 or 250 may include any suitable numbers of devices adapted for implementing embodiments of the present disclosure.

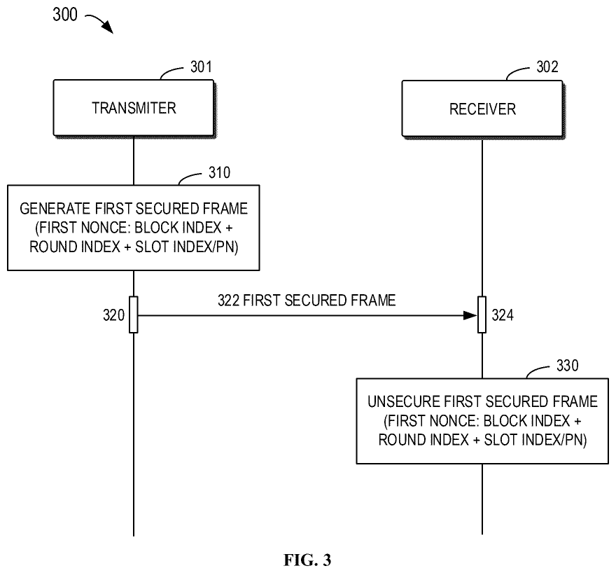

Reference is further made to FIG. 3, which illustrates a signaling chart illustrating communication process 300 in accordance with some example embodiments of the present disclosure. The process 300 may involve a transmitter 301 and a receiver 302. It is understood that the transmitter 301 may be the controller 210 or the controlee 220, and the receiver 302 may be the controlee 220 or the controller 210, with reference to FIG. 2A. It is understood that the transmitter 301 may be the initiator 260 or the responder 270, and the receiver 302 may be the responder 270 or the initiator 260, with reference to FIG. 2B.

The transmitter 301 generates 310 a first secured frame. The first secured frame is to be transmitted in a slot (such as a first slot) in a first round, where the first round is in a first block. The block-based time structure or the hyper block-based time structure may be utilized, where each block includes multiple rounds, and each round includes multiple slots. In some examples, in case the block-based time structure is utilized, different blocks include a same quantity of rounds, and different rounds include a same quantity of slots. In some other examples, in case the hyper block-based time structure is utilized, different blocks may include a same quantity of rounds or different quantities of rounds, and different rounds may include a same quantity of slots or different quantities of slots. The first secured frame may be secured by a first nonce, where the first nonce is constructed based on identifying information associated with the first secured frame, a round index and a block index, the round index is an index of the first round, and the block index is an index of the first block. In some embodiments, the transmitter 301 may construct the first nonce, and then generate the first secured frame. In some examples, the identifying information associated with the first secured frame may include a slot index or a first PN, which will be described in detail below.

In some example embodiments, the first secured frame may be transmitted during a measurement cycle. In some examples, the first nonce is constructed based on a slot index, a round index, and a block index. For example, the identifying information includes the slot index. The slot index is an index of the first slot in which the first secured frame transmitted, the round index is an index of the first round which the first slot belongs to, and the block index is an index of the first block which the first round belongs to.

The first nonce may include a first field carrying the slot index, a second field carrying the round index, and a third field carrying the block index. A length of the first field may equal to a first quantity, a length of the second field may equal to a second quantity, and a length of the third field may equal to a third quantity.

In some examples, the first quantity may be a first predefined quantity, such as 8 bits, or 10 bits, or another value. In some examples, the first quantity may be determined by a location of a start bit and a location of an end bit. For example, a location of a start bit and a location of an end bit of the first field may be predefined. In some other examples, the first quantity may be associated with a length of the first round, e.g., a quantity of slots in the first round. For example, the first quantity may be M bits, where M is an integer which can be determined by Equation (1):

$$M = ⌈ {log}_{2} ( \frac{round duration}{slot duration} ) ⌉ \qquad ( 1 )$$

where [X] refers to a ceiling function of a variable X, i.e., the smallest integer that is not less than (≥) X, “round duration” in Equation (1) refers to a time length of the first round, “slot duration” in Equation (1) refers to a time length of the first slot and

$$( \frac{round duration}{slot duration} )$$

in Equation (1) is the quantity of slots per round (represented as “NumSlots”). For example, a location of a start bit of the first field may be predefined, and a location of an end bit of the first field may be determined based on M.

In some examples, the second quantity may be a second predefined quantity, such as 15 bits, or 13 bits, or another value. In some examples, the second quantity may be determined by a location of a start bit and a location of an end bit. For example, a location of a start bit and a location of an end bit of the second field may be predefined. In some other examples, the second quantity may be associated with a length of the first block, e.g., a quantity of rounds in the first block. For example, the second quantity may be N bits, where n is an integer which can be determined by Equation (2):

$$N = ⌈ {log}_{2} ( \frac{block duration}{round duration} ) ⌉ \qquad ( 2 )$$

where “round duration” in Equation (2) refers to a time length of the first round, “block duration” in Equation (2) refers to a time length of the first block and

$$( \frac{block duration}{round duration} )$$

in Equation (2) is the quantity of rounds per block (represented as “NumRounds”). For example, a location of a start bit of the second field may be the bit after the first field, and a location of an end bit of the second field may be determined based on N.

In some examples, the third quantity may be a third predefined quantity, such as 16 bits, 18 bits, or another value. In some other examples, the third quantity may be determined based on at least one of the first quantity and the second quantity. For example, a sum of the first quantity, the second quantity, and the third quantity may equal to a predefined total quantity, thus the third quantity may be determined based on the predefined total quantity, the first quantity, and the second quantity. For example, the predefined total quantity may be 39 bits, 35 bits, or another value. Alternatively, a combination of the first field, the second field, and the third field may be regarded as a frame counter field, e.g., with a length of a predefined total quantity.

In the first nonce, the first field, the second field, and the third field may be consecutive, for example, the second field is located after the first field while the third field is located after the second field. However, it is to be understood that the present disclosure does not limit this aspect, for example there may be one or more reserved bits or one or more other fields between the first field and the second field, for example the third field may be located before the first field, etc., and the present disclosure will not list herein.

In addition, the first nonce may include a fourth field carrying a cycle index. A length of the fourth field may equal to a fourth quantity. In the present disclosure, a cycle may be newly defined, where a cycle includes one or more blocks. The cycle index is an index of a cycle which includes the first block. In some examples, the fourth quantity may be a fourth predefined quantity, such as 6 bits, 7 bits, 8 bits, or another value. In some other examples, the fourth quantity may be determined based on at least one of the first quantity, the second quantity, and the third quantity. For example, a sum of the first quantity, the second quantity, the third quantity, and the fourth quantity may equal to a predefined total quantity, thus the fourth quantity may be determined based on the predefined total quantity, the first quantity, the second quantity, and the third quantity. Alternatively, a combination of the first field, the second field, the third field, and the fourth field may be regarded as a frame counter field, e.g., with a length of a predefined total quantity.

The first nonce includes a first block indicator, where the first block indicator may indicate that the first secured frame is transmitted based on the block-based time structure or the hyper block-based time structure. For example, the first nonce may include a field carrying the first block indicator, e.g., a block indicator field. In some examples, the term “based on the block-based time structure or the hyper block-based time structure” may be called as “inside block structure”. The term “inside block structure” may refer to a time period in which the block-based time structure or the hyper block-based time structure has been known to both the transmitter 301 and the receiver 302. A length of the field carrying the first block indicator may be predefined, such as 1 bit, 2 bits, or another value. If the first block indicator equals to a first value, it may indicates that the first secured frame is in an inside block structure. For example, the first value may be 1 or 0. In some examples, the field carrying a first block indicator may be located in a predefined location of the first nonce, for example, at the end of the first nonce.

The first nonce includes a source address. For example, the first nonce may include a field carrying the source address, e.g., a source address field. A length of the field carrying the source address may be predefined, such as 8 octets, 10 octets, or another value. The field carrying the source address may be located in a predefined location of the first nonce, for example, at the front of the first nonce. The source address may be an extended address of the device originating the first secured frame, i.e., the address of the transmitter 301.

In some example embodiments, the first secured frame may be transmitted during a measurement cycle. As some examples, the first secured frame may be any of: secured POLL, secured RESP, or secured RPRT.

The first secured frame may include a first block index presence indicator and a first round index presence indicator. The first block index presence indicator may indicate whether there is a block index in the first secured frame. The first round index presence indicator may indicate whether there is a round index in the first secured frame. For example, the first block index presence indicator equals to a first value to indicate that there is a block index in the first secured frame, or equals to a second value to indicate that there is not a block index in the first secured frame. For example, the first round index presence indicator equals to a first value to indicate that there is a round index in the first secured frame, or equals to a second value to indicate that there is not a round index in the first secured frame. The first value is 1 and the second value is 0, or the first value is 0 and the second value is 1.

For example, the first secured frame may include a first block index presence field carrying a first block index presence indicator and a first round index presence field carrying a first round index presence indicator. Alternatively, the first secured frame may include a presence control field (with a predefined length, such as 1 octet) which includes the first block index presence field and the first round index presence field. In some examples, a length of the first block index presence field may be 1 bit, 2 bits, or another value, and a length of the first round index presence field may be 1 bit, 2 bits, or another value.

The first secured frame may include the block index. For example, if the first block index presence indicator indicates a presence of the block index, e.g., the first block index presence indicator equals to a first value. For example, the first secured frame may include a first block index field carrying the block index. Alternatively, a length of the first block index field may be predefined, such as 2 octets, 15 bits, or another value. It is understood that there is no first block index field included if the first block index presence indicator equals to a second value, in other words, a length of the first block index field is 0.

The first secured frame may include the round index. For example, if the first round index presence indicator indicates a presence of the round index, e.g., the first round index presence indicator equals to a first value. For example, the first secured frame may include a first block index field carrying the block index. Alternatively, a length of the first round index field may be predefined, such as 2 octets, 15 bits, or another value. It is understood that there is no first round index field included if the first round index presence indicator equals to a second value, in other words, a length of the first round index field is 0.

Alternatively, the first secured frame may include an open payload, which includes the first block index presence field, the first round index presence field, the first block index field (if exists), and the first round index field (if exists).

The first secured frame may include a first security indicator. For example, the first secured frame may include a field carrying the first security indicator, e.g., a security indicator field. The first security indicator may indicate that the first secured frame is secured. For example, a length of the field carrying the first security indicator may be predefined, such as 1 bit, 2 bits, or another value.

The first secured frame may further include one or more of: a field carrying an ID, a field carrying an address, a field carrying secured payload, and a field carrying a message integrity check (MIC). The secured payload in the first secured frame may be generated based on the first nonce. In some examples, a security key may be used for generating the secured payload in the first secured frame.

The transmitter 301 sends 320 the first secured frame 322 to the receiver 302. And the receiver 302 receives 324 the first secured frame 322. The receiver 302 unsecures 330 the first secured frame 322. Further, the receiver 302 unsecures the first secured frame 322 by a nonce constructed based on a round index and a block index.

It is to be understood that the transmitter 301 and the receiver 302 should have a consistent standard to construct the nonce, in other words, the nonce constructed by the receiver 302 should be the same as the first nonce used for securing the first secured frame constructed by the transmitter 301. If the nonce constructed by the receiver 302 is different from the first nonce used for securing the first secured frame constructed by the transmitter 301, then the unsecuring of the first secured frame will be failed.

In some embodiments, the receiver 302 may construct the first nonce, and then unsecures the first secured frame 322. The first nonce constructed by the receiver 302 is similar with that described above, i.e., constructed by the transmitter, and will not described in detail for ease of brevity.

As mentioned, the first nonce may include three fields carrying a slot index, a round index, and a block index respectively. In some other examples, the first nonce may include two fields, one of which carrying one of the slot index, the round index, and the block index, and the other of which carrying a combination of the other two of the slot index, the round index, and the block index. For example, one field of the first nonce carries the slot index, and another field of the first nonce carries a function of the round index and the block index. In some other examples, the first nonce may include a field carrying a value (such as a frame counter (FC)) which is a function of the slot index, the round index, and the block index. It should be understood that the first nonce may be determined based on the slot index, the round index, and the block index in another way, the present disclosure does not limit this aspect.

In addition, the transmitter 301 may generate a second secured frame. The second secured frame will be transmitted not based on the block-based time structure or the hyper block-based time structure; in other words, the second secured frame will be transmitted in a non-block-based time structure or a non-hyper block-based time structure or another structure. In some examples, the term “not based on the block-based time structure” or “non-block-based time structure” or the “not based on hyper block-based time structure” or “non-hyper block-based time structure” may be called as “outside block structure”. The term “outside block structure” may refer to a time period in which the block-based time structure or the hyper block-based time structure is not been known to either the transmitter 301 or the receiver 302.

The second secured frame may be secured by a second nonce, where the second nonce is constructed based on a second PN, the second PN is a packet number of the second secured frame. In some embodiments, the transmitter 301 may construct the second nonce, and then generate the second secured frame.

In some examples, the second nonce may include a field carrying the second PN. A length of the field carrying the second PN may equal to a predefined quantity, such as 4 octets, 3 octets, or another value.

The second nonce includes a field carrying a second block indicator, where the second block indicator may indicate that the second secured frame is transmitted in the outside block structure. A length of the field carrying the second block indicator may be predefined, such as 1 bit, 2 bits, or another value. If the second block indicator equals to a second value, it may indicate that the second secured frame is in an outside block structure. For example, the second value may be different from a first value of the first block indicator which indicates that the first secured frame is in an inside block structure. For example, the first value is 1 and the second value is 0. For another example, the first value is 0 and the second value is 1. In some examples, the field carrying a second block indicator may be located in a predefined location of the second nonce, for example, at the end of the second nonce.

The second nonce includes a field carrying a source address. A length of the field carrying the source address may be predefined, such as 8 octets, 7 octets, or another value. The field carrying the source address may be located in a predefined location of the second nonce, for example, at the front of the second nonce. The source address may be an extended address of the device originating the second secured frame, i.e., the address of the transmitter 301.

In some example embodiments, the second secured frame may be transmitted during an initialization and setup phase. As some examples, the second secured frame may be any of: secured ADV-RESP, or secured SOR.

The second secured frame may include a PN field carrying the second PN. A length of the PN field in the second secured frame may be predefined, such as 4 octets, 3 octets, or another value.

The second secured frame may include a field carrying a second security indicator. The second security indicator may indicate that the second secured frame is secured. For example, a length of the field carrying the second security indicator may be predefined, such as 1 bit, 2 bits, or another value.

The second secured frame may further include one or more of: a field carrying an ID, a field carrying an address, a field carrying a security level, a field carrying secured payload, and a field carrying a MIC. The secured payload in the second secured frame may be generated based on the second nonce. In some examples, a security key may be used for generating the secured payload in the second secured frame.

In some examples, the secured payload may include a second block index presence field carrying a second block index presence indicator, a second round index presence field carrying a second round index presence indicator, and a second slot index presence field carrying a second slot index presence indicator. The second block index presence indicator may indicate whether there is a second block index field. The second round index presence indicator may indicate whether there is a second round index field. The second slot index presence indicator may indicate whether there is a second slot index field.

For example, the second block index presence indicator equals to a first value to indicate that there is a second block index field in the secured payload, or equals to a second value to indicate that there is not a second block index field in the secured payload. For example, the second round index presence indicator equals to a first value to indicate that there is a second round index field in the secured payload, or equals to a second value to indicate that there is not a second round index field in the secured payload. For example, the second slot index presence indicator equals to a first value to indicate that there is a second slot index field in the secured payload, or equals to a second value to indicate that there is not a second slot index field in the secured payload. The first value is 1 and the second value is 0, or the first value is 0 and the second value is 1. Alternatively, the secured payload may include a presence control field (with a predefined length, such as 1 octet) which includes the second block index presence field, the second round index presence field, and the second slot index presence field. In some examples, a length of the second block index presence field may be 1 bit, 2 bits, or another value, a length of the second round index presence field may be 1 bit, 2 bits, or another value, and a length of the second slot index presence field may be 1 bit, 2 bits, or another value.

The secured payload may include a second block index field carrying a block index. For example, if the second block index presence indicator in the second block index presence field indicates a presence of the second block index field, e.g., the second block index presence indicator equals to a first value, there is the second block index field carrying the block index. Alternatively, a length of the second block index field may be predefined, such as 2 octets, 15 bits, or another value. It is understood that there is no second block index field included if the second block index presence indicator equals to a second value, in other words, a length of the second block index field is 0.

The secured payload may include a second round index field carrying a round index. For example, if the second round index presence indicator in the second round index presence field indicates a presence of the second round index field, e.g., the second round index presence indicator equals to a first value, there is the second round index field carrying the round index. Alternatively, a length of the second round index field may be predefined, such as 2 octets, 15 bits, or another value. It is understood that there is no second round index field included if the second round index presence indicator equals to a second value, in other words, a length of the second round index field is 0.

The secured payload may include a second slot index field carrying a slot index. For example, if the second slot index presence indicator in the second slot index presence field indicates a presence of the second slot index field, e.g., the second slot index presence indicator equals to a first value, there is the second slot index field carrying the slot index. Alternatively, a length of the second slot index field may be predefined, such as 2 octets, 15 bits, or another value. It is understood that there is no second slot index field included if the second slot index presence indicator equals to a second value, in other words, a length of the second slot index field is 0.

The transmitter 301 sends the second secured frame to the receiver 302 and the receiver 302 receives the second secured frame. The receiver 302 unsecures the second secured frame. Further, the receiver 302 unsecures the second secured frame by a nonce constructed based on a second PN.

As mentioned above, the transmitter 301 and the receiver 302 should have a consistent standard to construct the nonce, in other words, the nonce constructed by the receiver 302 should be the same as the second nonce used for securing the second secured frame constructed by the transmitter 301. If the nonce constructed by the receiver 302 which is used for unsecuring the second secured frame is different from the second nonce used for securing the second secured frame constructed by the transmitter 301, then the unsecuring of the second secured frame will fail.

In some embodiments, the receiver 302 may construct the second nonce, and then unsecures the second secured frame. The second nonce constructed by the receiver 302 is similar with that described above, i.e., constructed by the transmitter, and will not described in detail for ease of brevity.

In case the second secured frame is unsecured by the receiver 302, information in the secured payload of the second secured frame may be obtained by the receiver 302. In some examples, if the second block index field, the second round index field, and the second slot index field are included, the carried block index, round index, and slot index may be obtained by the receiver 302. In some other examples, if at least one of the second block index field, the second round index field, and the second slot index field is not included, the receiver 302 may determine a corresponding index by itself. For example, if there is no second block index field included in the secured payload, the receiver 302 may determine the block index as a default value, such as block index 0. Therefore, in case an index is a default value (such as 0), there is no needed to included it in the secured payload, thus the signaling overhead can be saved.

According to some embodiments described above, different nonce may be used for securing frames during an initialization and setup phase and measurement cycles. Further, a PN may be used for constructing a nonce for securing a frame transmitted in the “outside block structure”, and a slot index, a round index, and a block index may be used for constructing a nonce for securing a frame transmitted in the “inside block structure”.

In some other example embodiments, the first secured frame generated by the transmitter 301 at 310 may be transmitted during an initialization and setup phase or during a measurement cycle. Further, the block-based time structure or the hyper block-based time structure may be set up before or at a beginning of the initialization and setup phase. In this event, a frame transmitted during the initialization and setup phase is also in the block-based time structure or the hyper block-based time structure.

The first nonce which is used for securing the first secured frame is constructed based on a block index, a round index, and a first PN. The round index is an index of the first round in which the first secured frame transmitted, and the block index is an index of the first block which the first round belongs to. The first PN is a packet number of the first secured frame. In other words, the first PN is used to uniquely identify the first secured frame.

The first nonce may include a first field carrying the first PN, a second field carrying the round index, and a third field carrying the block index. A length of the first field may equal to a first quantity, a length of the second field may equal to a second quantity, and a length of the third field may equal to a third quantity.

In some examples, the first quantity may be a first predefined quantity, such as 8 bits, 7 bits, or another value. In some examples, the first quantity may be determined by a location of a start bit and a location of an end bit. For example, a location of a start bit and a location of an end bit of the first field may be predefined.

In some examples, the second quantity may be a second predefined quantity, such as 15 bits, 16 bits, or another value. In some examples, the second quantity may be determined by a location of a start bit and a location of an end bit. For example, a location of a start bit and a location of an end bit of the second field may be predefined. In some other examples, the second quantity may be associated with a length of the first block, e.g., a quantity of rounds in the first block. For example, the second quantity may be N bits, where N is an integer which can be determined by Equation (2) stated above.

In some examples, the third quantity may be a third predefined quantity, such as 16 bits, 17 bits, or another value. In some other examples, the third quantity may be determined based on at least one of the first quantity and the second quantity. For example, a sum of the first quantity, the second quantity, and the third quantity may equal to a predefined total quantity, thus the third quantity may be determined based on the predefined total quantity, the first quantity, and the second quantity. For example, the predefined total quantity may be 40 bits, 39 bits, or another value. Alternatively, a combination of the first field, the second field, and the third field may be regarded as a frame counter field, e.g., with a length of a predefined total quantity.

In the first nonce, the first field, the second field, and the third field may be consecutive, for example, the second field is located after the first field while the third field is located after the second field. However, it is to be understood that the present disclosure does not limit this aspect, for example there may be one or more reserved bits between the first field and the second field, for example the third field may be located before the first field, the present disclosure will not list herein.

The first nonce includes a field carrying a source address. A length of the field carrying the source address may be predefined, such as 8 octets, 7 octets, or another value. The field carrying the source address may be located in a predefined location of the first nonce, for example, at the front of the first nonce. The source address may be an extended address of the device originating the first secured frame, i.e., the address of the transmitter 301.

Similarly, the transmitter 301 sends 320 the first secured frame 322 which is secured by the first nonce being constructed based on the first PN, the round index, and the block index. And the receiver 302 may receive 324 the first secured frame 322. The receiver 302 unsecures 330 the first secured frame 322. Further, the receiver 302 may construct the first nonce based on the first PN, the round index, and the block index, and unsecure the first secured frame 322 by using the first nonce.

As mentioned, the first nonce may include three fields carrying a first PN, a round index, and a block index respectively. In some other examples, the first nonce may include two fields, one of which carrying one of the first PN, the round index, and the block index, and the other of which carrying a combination of the other two of the first PN, the round index, and the block index. For example, one field of the first nonce carries the first PN, and another field of the first nonce carries a function of the round index and the block index. In some other examples, the first nonce may include a field carrying a value (such as a frame counter (FC)) which is a function of the first PN, the round index, and the block index. It should be understood that the first nonce may be determined based on the first PN, the round index, and the block index in another way, the present disclosure does not limit this aspect.

According to some embodiments described above, in case the block-based time structure or the hyper block-based time structure may be set up before or at a beginning of the initialization and setup phase, a PN, a round index, and a block index may be used for constructing a nonce for securing a frame.

Some embodiments above have described that the identifying information associated with the first secured frame may include a slot index or a first PN, in some other examples, the identifying information associated with the first secured frame may include both the slot index and the first PN, in some other examples, the identifying information associated with the first secured frame may include a parameter or a value specific (or unique) to the first secured frame, the present disclosure does not limit this aspect.

In the present disclosure, a secured frame is generated by securing a compressed frame, where a compressed frame may be a compressed PSDU frame or a frame with a compressed header IE format being described above. Or the secured frame may be generated by securing an 802.15.4 frame that does not carry the frame counter field. The securing operation may be performed by using a cryptographic operation, such as an authentication or an encryption.

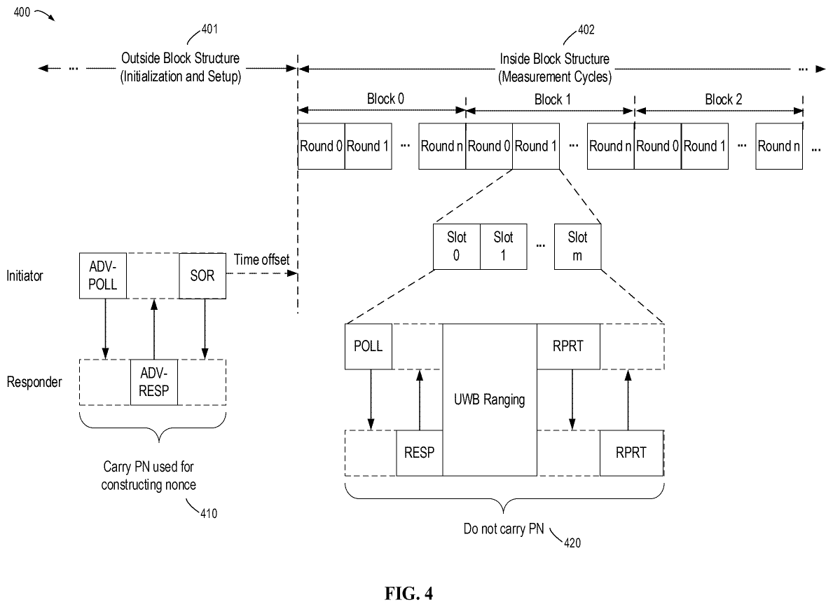

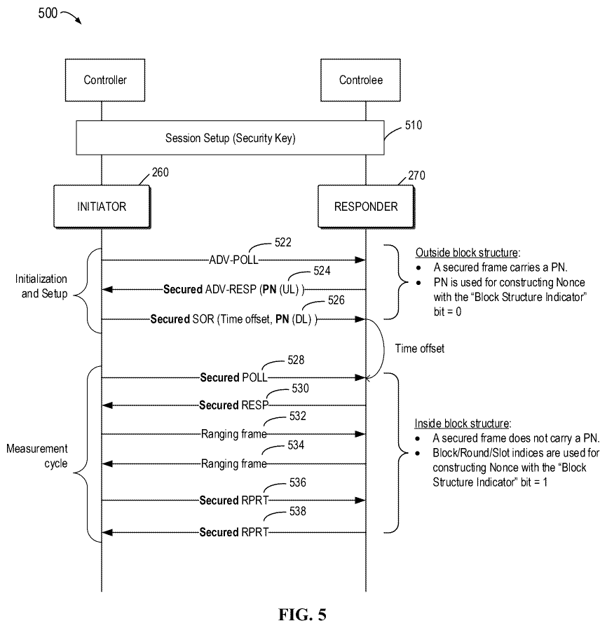

FIG. 4 illustrates a schematic diagram of an example MMS ranging session 400 in a block-based time structure in accordance with some example embodiments of the present disclosure. As shown in FIG. 4, the MMS ranging session 400 includes an initialization and setup phase 401 followed by one or more measurement cycles 402.

During the initialization and setup phase 401, a responder may not be aware of the block-based time structure, thus the initialization and setup phase 401 is considered as being “outside block structure”. During one or more measurement cycles 402, both the initiator and the responder participating the MMS ranging session will be aware of the block-based time structure, thus the one or more measurement cycles 402 is considered as being “inside block structure”.

As shown at 410, during the initialization and setup phase 401, a PN is used for constructing a nonce and it is understood that a transmission duration of a frame during the initialization and setup phase 401 is not necessarily be limited to 1 ms.

During the one or more measurement cycles 402, a transmitter (an initiator or a responder) may only transmit a single frame in one slot, thus each frame is uniquely associated with a particular slot. Accordingly, a slot index, a round index, and a block index can be used for constructing a nonce which is used for securing a frame transmitted in the slot. Since the indices are strictly incrementing, it can be guaranteed that the slot index, the round index, and the block index used to construct the nonce will not repeat in the present block structure, and hence the frame need not carry any PN, as shown at 420.

FIG. 5 illustrates a signaling chart illustrating a process 500 of an example MMS ranging session in accordance with some example embodiments of the present disclosure.

The process 500 begins with a controller and a controlee performing a session setup 510. During the session setup 510, long-term session parameters such as a UWB channel number, preamble codes, a default block structure (such as number of blocks, block durations) etc. are negotiated. With reference to FIG. 4, the long-term session parameters include default values of m and n, where m is associated with a quantity of slots in each round (e.g., NumSlots=m+1 as shown in FIG. 4) and n is associated with a quantity of rounds in each block (e.g., NumRounds=n+1 as shown in FIG. 4). The long-term parameters are not expected to change during the MMS ranging session. When security is enabled, at least one security key will also be provided by the controller to the controlee to secure unicast frame (i.e., frames that are exchanged between the responder and the initiator). If security is enabled for broadcast frames as well, then a separate security key common to all responders are also provided. For an NBA-MMS ranging session, parameters related to narrow band (such as NB channel number, etc.) may also be negotiated during the session setup 510.

Some other parameters such as number of MMS fragments, report mode etc. may be considered short term parameters since they may be modified during the MMS ranging session. The session setup 510 may be performed out-of-band, for example using BLUETOOTH or Wi-Fi radio, or may also be performed in-band, for example using narrow band or UWB radio.

Additionally, the roles of initiator and responder are also assigned during the session setup 510. As a specific example shown in FIG. 5, it is assumed that the controller takes the role of initiator 260 and the controlee is assigned the role of responder 270. However, it is to be understood that it is also possible that the controlee may be assigned the role of initiator while the controller assumes the role of responder.

At 522, the initiator 260 transmits the ADV-POLL frames opportunistically at times and intervals to its discretion while the responder 270 may opportunistically listen for incoming ADV-POLL frames. At 524, the responder 270 responds with the ADV-RESP frame if the responder 270 intends to participate in a ranging session with the initiator 260. If security is enabled, the ADV-RESP frame carries a PN that is used to construct the nonce for securing the ADV-RESP frame. As shown in FIG. 5, a secured ADV-RESP frame may be transmitted from the responder 270 to the initiator 260.

At 526, once the initiator 260 has received an ADV-RESP frame, it transmits the SOR frame that provides a time offset at which the first range-measurement cycle will start. If security is enabled, the SOR frame carries a PN that is used to construct the nonce used for securing the SOR frame. As shown in FIG. 5, a secured SOR frame may be transmitted from the initiator 260 to the responder 270. It is to be noted that the PN for UL and the PN for DL may be used separately, in other words, different number spaces may be used for the PN in the uplink (responder to initiator) and downlink (initiator to responder) directions and the PN is incremented by one every time a frame carrying the PN is transmitted.

At 528, the initiator 260 transmits a secured POLL frame to the responder 270 at the beginning of the first slot of a round, where the beginning of the first slot is indicated by the time offset in the SOR frame. The initiator 260 may also include other control information in the POLL frame for the responder 270. At 530, the responder 270 transmits a secured RESP frame back to the initiator 260 in case it receives the secured POLL frame successfully. The POLL and RESP frames allow the initiator 260 and responder 270 to achieve a time and frequency synchronization.

In the ranging phase, the initiator 260 and the responder 270 may exchange zero or more UWB RSFs and optionally one or more UWB RIFs. The RSFs are used to perform ranging measurements while the RIFs are used to check the integrity of the ranging measurements. Illustratively, the exchanging is shown at 532 and 534 in FIG. 5.

After the initiator 260 or the responder 270 completes the reception of all UWB fragments for the ranging phase, a report phase may start. During the report phase, the initiator 260 or the responder 270 may generate a ranging measurement report, and send a secured RPRT frame carrying the measurement report to the peer device. As shown in FIG. 5, the initiator 260 sends a secured RPRT frame to the responder 270 at 536, while the responder 270 sends a secured RPRT frame to the initiator 260 at 538.

The slot index of the respective slot in which the corresponding frame is transmitted, together with the indices of the round and the block in which the slot is located, may be used to construct the nonce for securing the POLL, RESP, and RPRT frames.

Some example formats of frames and nonce are shown in the present disclosure with reference to drawing. However, it should be noted that the examples are given for the purpose of illustration without suggesting any limitations to the present disclosure. For example, a frame or nonce may include multiple fields, one or more fields may be omitted in some cases, one or more un-shown fields may further included. For example, two or more fields may be combined as one field. For example, one field may be replaced by one or more different fields. For example, a field carrying information may be split into two fields, one field carrying the information and the other one field being reserved. For example, each length (in unit of octets or bits) may be a fixed value or an adjusted value. For example, an arrangement of the fields may be in another way, e.g., in a different order. The present disclosure does not limit this aspect.

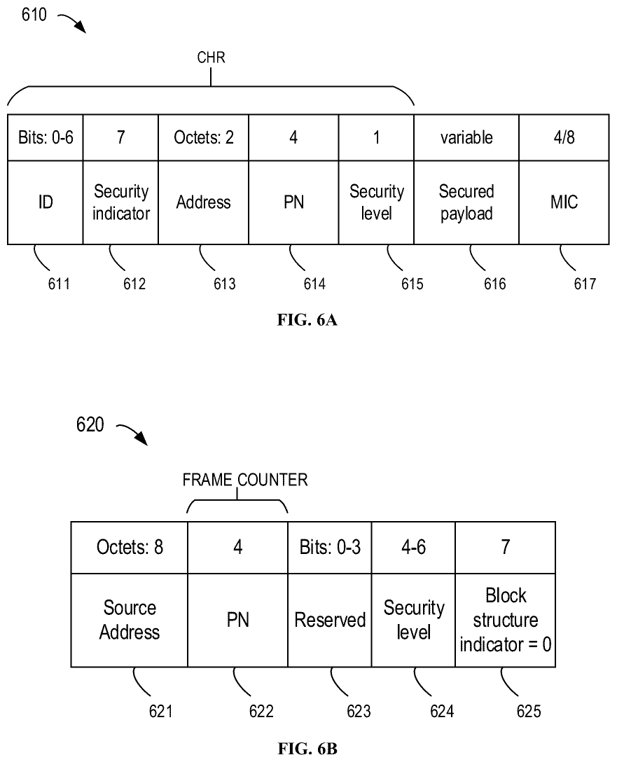

FIG. 6A illustrates a schematic diagram of a format of an SOR frame 610 in accordance with some example embodiments of the present disclosure. For example, the SOR frame 610 may be a secured SOR frame transmitted at 526 in FIG. 5. Although the SOR frame 610 is shown in the compressed PSDU format, the procedure described works even if the frame is carried as a compressed header ID format or even as a 802.15.4 frame.

As shown in FIG. 6A, the SOR frame 610 includes a field 611 carrying an ID, a field 612 carrying a security indicator, a field 613 carrying an address, a field 614 carrying a PN, a field 615 carrying a security level, a field 616 carrying secured payload, and a field 617 carrying the MIC. When carried as a 802.15.4 frame, the PN field 614 and the security level field 615 may be carried within the auxiliary security header field in the MHR.

The fields 611-615 may be considered as a compressed header (CHR) of the SOR frame 610, where the fields 611-613 are mandatory while the fields 614-165 are optional. For example, if the frame is not secured, the field 614 may be not included. For example, if a security level is negotiated beforehand, the field 615 may be omitted.

The field 611 may indicate an identity of the SOR frame 610, e.g., the field 611 carries “0x22” indicating an SOR frame. The field 612 may indicate whether the frame is secured. In some examples, the field 612 may be the most significant bit (MSB) of the field 611, e.g., carrying “1” or “0”. For example, “1” indicates that the frame is secured while “0” indicates that the frame is unsecured. As shown in FIG. 6A, a total length of the field 611 and the field 612 may be 1 octet.

The field 614 may carry a packet number of the SOR frame 610. In some examples, the initiator 260 may maintain a separate number space for each responder 270 of a secured compressed frame to ensure that the same nonce is never reused with the same security key. For example, a first number space is associated with a responder 270-1 and a second number space is associated with a responder 270-2. As shown in FIG. 6A, a length of the field 614 may be 4 octets. In case the SOR frame is addressed to multiple responders, the PN may be the same for all responders and a separate security key negotiated for broadcast transmissions is used to secure or unsecure the SOR frame.

The field 615 may indicate a security level that is applied to the security operation on the frame. Alternatively, if the security level is negotiated during the session setup 510 and is assumed to be fixed for the entire ranging session, the field 615 may be omitted.

When the SOR frame 610 is encrypted, e.g., the security level is one of 5, 6, or 7, the field 616 is secured (i.e., encrypted). For example, the field 616 carries secured payload.

The field 617 carries the MIC generated by an AEAD transformation process. The size of the MIC depends on the security level. For example, the security level is 5 or 6, and accordingly a length of the field 617 is 4 octets or 8 octets. It is also possible that only a portion of the MIC (e.g., the least signification 16 bits) is carried in the MIC field and the same 16 bits are used for integrity checking by the responders.

It is to be understood that since the MIC can detect any errors in the frame content, a CRC field is not needed any more, in other words, the CRC field can be replaced by the MIC field.

It is to be understood that the SOR frame 610 in FIG. 6A may be considered as a secured SOR frame, in some other examples, if an unsecured SOR frame is used, the field 614 and the field 615 are not included, and the payload in field 616 is unsecured payload.

It is also to be understood that although FIG. 6A illustrates a format of an SOR frame, a similar format may be applied to secured ADV-RESP, which will not be described herein.

FIG. 6B illustrates a schematic diagram of a format of a nonce 620 for securing a frame transmitted in the outside block structure in accordance with some example embodiments of the present disclosure. For example, the nonce 620 may be constructed by the initiator 260 for securing the SOR or for unsecuring the ADV-RESP, or be constructed by the responder for securing the ADV-RESP or for unsecuring the SOR. Alternatively, the nonce 620 may be called as an outside block-based nonce.

As shown in FIG. 6B, the nonce 620 includes a frame 621 carrying a source address, a field 622 carrying a PN, a field 623 reserved, a field 624 carrying a security level, and a field 615 carrying a block structure indicator.

The field 621 may indicate an extended address of the device originating the frame. It is understandable that the controller and the controlee will exchange and save peer device's extended address during session setup 510.

The field 622 may be considered as a frame counter field, which can be set to a PN, which is identical to a value of a PN field of the secured frame. For example, if the nonce 620 is constructed by the initiator 260 for securing the SOR frame, or is constructed by the responder 270 for unsecuring the secured SOR frame, the PN in the field 622 should be the same as that in field 614. A length of the field 622 may be 4 octets.

The field 624 may indicate a security level, i.e., a nonce security level. The security level may be an integer that identical to a value of a security level field of the secured frame. For example, if the nonce 620 is constructed by the initiator 260 for securing the SOR frame, or is constructed by the responder 270 for unsecuring the secured SOR frame, the security level in the field 624 should be the same as that in field 615. However, as described with reference to FIG. 6A, the field 615 may be omitted in case the security level is negotiated during the session setup 510, in which case the Security Level field 624 is set to the security level negotiated during the session setup 510.

The field 625 may indicate a block structure indicator (or block indicator). In some examples, the field 625 may be the last one bit of the nonce 620, e.g., carrying “1” or “0”. For example, “1” indicates that the frame is in block structure while “0” indicates that the frame is transmitted in the outside block structure. As shown in FIG. 6B, since the nonce 620 is used for the initialization and setup phase, the block structure indicator is 0.

It is to be understood than the block structure indicator is used to ensure that the nonce for securing frames transmitted inside and outside block structure may be never reused, for example, the block structure indicator may be set as “0” in case the frame is transmitted or received outside block structure.

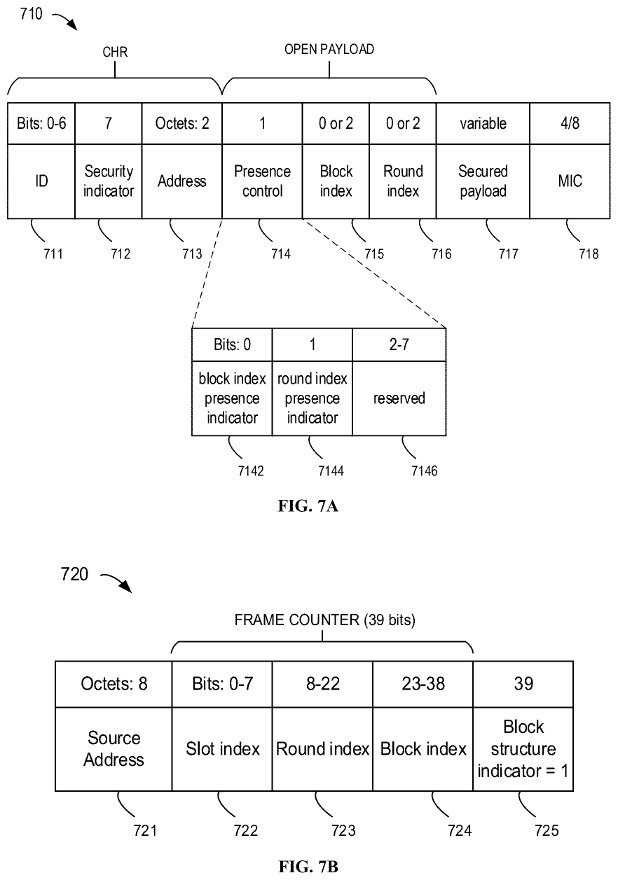

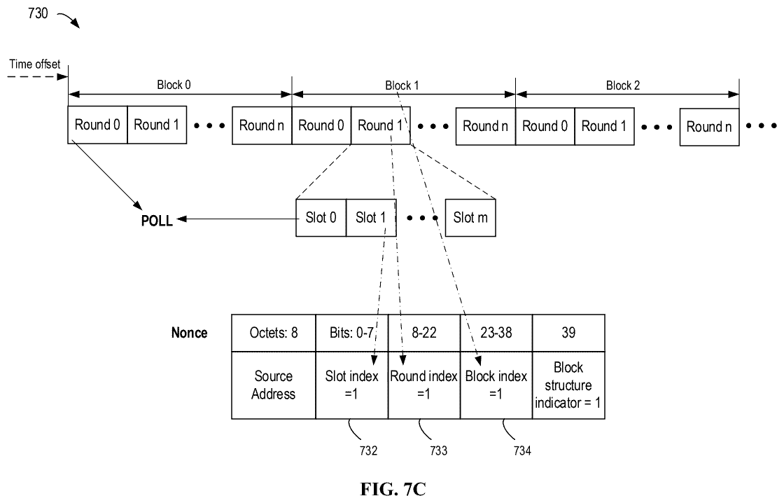

FIG. 7A illustrates a schematic diagram of a format of a POLL frame 710 in accordance with some example embodiments of the present disclosure. For example, the POLL frame 710 may be a secured POLL frame transmitted at 528 in FIG. 5.

As shown in FIG. 7A, the POLL frame 710 includes a field 711 carrying an ID, a field 712 carrying a security indicator, a field 713 carrying an address, a field 714 which is a presence control field, a field 715 carrying a block index, a field 716 carrying a round index, a field 717 carrying secured payload, and a field 718 carrying the MIC.

The fields 711-713 may be considered as a CHR of the POLL frame 710. The field 711 may indicate an identity of the POLL frame 710. The field 712 may indicate whether the frame is secured. In some examples, the field 712 may be the MSB of the field 711, e.g., carrying “1” or “0”. For example, “1” indicates that the frame is secured while “0” indicates that the frame is unsecured. As shown in FIG. 7A, a total length of the field 711 and the field 712 may be 1 octet.

The fields 714-716 may be considered as open payload of the POLL frame 710. The open payload of a secure frame may be authenticated but not encrypted regardless of the security level. The field 714 includes a block index presence field 7142 carrying a block index presence indicator, a round index presence field 7144 carrying a round index presence indicator, and a reserved field 7146. As shown in FIG. 7A, a length of the field 714 may be 1 octet.

In some examples, the block index presence indicator equals to a first value (such as 1) to indicate that a presence of the field 715, and the round index presence indicator equals to a first value (such as 1) to indicate that a presence of the field 716, in the open payload. For example, a length of the field 715 may be 2 octets, and a length of the field 716 may be 2 octets. In some other examples, the block index presence indicator equals to a second value (such as 0) to indicate that there is no field 715, in other words, a length of the field 715 is 0. In some other examples, the round index presence indicator equals to a second value (such as 0) to indicate that there is no field 716, in other words, a length of the field 716 is 0. For example, if the block index is a default value (such as 0), the field 715 may be omitted. For example, if the round index is a default value (such as 0), the field 716 may be omitted.

When the POLL frame 710 is encrypted, e.g., the security level is one of 5, 6, or 7, the field 717 is secured (i.e., encrypted). For example, the field 717 carries secured payload. The field 718 carries the MIC generated by an AEAD transformation process. The size of the MIC depends on the security level. For example, the security level is 5 or 6, and accordingly a length of the field 718 is 4 octets or 8 octets.

Alternatively, the POLL frame 710 may include a field carrying a security level, which is similar with the field 615 in FIG. 6A.

It is to be understood that the POLL frame 710 in FIG. 7A may be considered as a secured POLL frame. The secured POLL frame 710 is transmitted in the first slot of the round indicated by the SOR frame (such as the secured SOR frame 610), allowing a receiver of the secured POLL frame 710 (the responder 270) to synchronize to the block structure.

It is also to be understood that although FIG. 7A illustrates a format of a POLL frame, a similar format may be applied to a secured RESP or a secured RPRT, which will not be described herein.

FIG. 7B illustrates a schematic diagram of a format of a nonce 720 for securing a frame inside block structure in accordance with some example embodiments of the present disclosure. For example, the nonce 720 may be constructed by the initiator 260 for securing the POLL, unsecuring the secured RESP, securing the RPRT, or unsecuring the secured RPRT, or be constructed by the responder for unsecuring the secured POLL, securing the RESP, unsecuring the secured RPRT, or securing the RPRT. Alternatively, the nonce 720 may be called as an inside block-based nonce.

As shown in FIG. 7B, the nonce 720 includes a frame 721 carrying a source address, a field 722 carrying a slot index, a field 723 carrying a round index, a field 724 carrying a block index, and a field 725 carrying a block structure indicator.

The field 721 may indicate an extended address of the device originating the frame. It is understandable that the controller and the controlee will exchange and save peer device's extended address during session setup 510.

The fields 722-724 may be considered as a frame counter field of the nonce 720. The fields 722-724 may be set as indices of the slot, the round, and block in which the frame is transmitted (while securing) or received (while unsecuring). As shown in FIG. 7B, each length of the fields 722-724 is predefined, and a total quantity of the lengths is 39 bits.

The field 725 may indicate a block structure indicator (or block indicator). In some examples, the field 725 may be the last one bit of the nonce 720, e.g., carrying “1” or “0”. For example, “1” indicates that the frame is in block structure while “0” indicates that the frame is transmitted in the outside block structure. As shown in FIG. 7B, since the nonce 720 is used for the measurement cycle, the block structure indicator is 1.

Alternatively, the nonce 720 may include a field carrying a security level, which is similar with the field 624 in FIG. 6B.

In some examples, the field 724 may be split into two fields, one of which carrying the block index and the other one being reserved. In some examples, an order of the fields 722-724 may be in another way, such as an inverse order as show in FIG. 7B.

It is to be understood than the block structure indicator is used to ensure that the nonce for securing frames transmitted inside and outside block structure may be never reused, for example, the block structure indicator may be set as “0” in case the frame is transmitted or received in the outside block structure.

FIG. 7C illustrates an example 730 of constructing the nonce for securing a compressed frame in accordance with some example embodiments of the present disclosure. As shown in FIG. 7C, if the secured frame is to be transmitted in slot 1 of round 1 of block 1 in the block-based time structure, then the nonce may include a field 732 carrying a slot index 1, a field 733 carrying a round index 1, and a field carrying a block index 1.

It is to be understood that the example 730 is also applied for the responder for unsecuring the secured frame, for example, the secured frame is received in slot 1 of round 1 of block 1 in the block-based time structure, and the nonce is constructed in a same way.

As described with reference to FIGS. 7B-7C, lengths of fields carrying a slot index, a rounding index, and a block index may be set as fixed values, such as 8 bits, 15 bits, and 16 bits respectively. In the present disclosure, in one slot there may be one single frame being transmitted, to ensure that the nonce will never repeat for a same security key. In this case, a larger number of frame counter values may be needed and accordingly the frame counter space may be run out fast. Therefore, the security key needs to be changed if the frame counter wraps around (i.e., rolls over to 0) to ensure that the nonce never repeats for the same security key.

Table 1 below shows an increment of the frame counter value in an inside block-based nonce (such as nonce 720) if the secured frame is transmitted or received in the first slot of different rounds in 3 consecutive blocks. It can be seen that the frame counter value increment by 8,388,865 every time the block index updates. For example, for a block structure with 96 ms block duration, the frame counter will wrap around in 6291s=104 minutes.

TABLE 1

| Block Index | Round Index | Slot Index | Frame Counter |
|---|---|---|---|
| (16 bits) | (15 bits) | (8 bits) | Value |
| 0x0000 | 0x0000 | 0x01 | 1 |
| 0x0001 | 0x0001 | 0x01 | 8,388,865 |
| 0x0002 | 0x0007 | 0x01 | 16,779,009 |

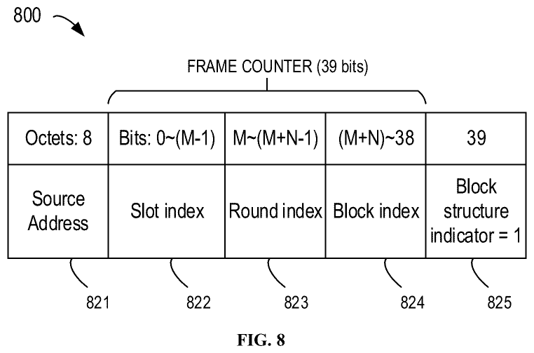

FIG. 8 illustrates a schematic diagram of another format of a nonce 800 for securing a frame inside block structure in accordance with some example embodiments of the present disclosure. Alternatively, the nonce 820 may be called as an inside block-based nonce.

As shown in FIG. 8, the nonce 800 includes a frame 821 carrying a source address, a field 822 carrying a slot index, a field 823 carrying a round index, a field 824 carrying a block index, and a field 825 carrying a block structure indicator. It is noted that the nonce 800 is similar with the nonce 720 in FIG. 7B, however, lengths of the fields 822-824 are not fixed values.

For example, a length of the field 822 (i.e., a first quantity of bits), a length of the field 823 (i.e., a second quantity of bits), and a length of the field 824 (i.e., a third quantity of bits) may be determined based the block-based time structure. Further, the values of M and N in FIG. 8 may be determined based on Equations (1) and (2) respectively. In some examples, the values of M and N may be signaled by the initiator 260, e.g., in the SOR frame 610.

Alternatively, the nonce 800 may include a field carrying a security level, which is similar with the field 624 in FIG. 6B. Alternatively, the field 814 may be split into three fields in some other examples, one field carrying the block index, one field carrying a security level, and one field being reserved.

As a specific example, it is assumed that each block includes 16 rounds and each round includes 16 slots, as such the quantity of slots per round (NumSlots)=the quantity of rounds per block (NumRounds)=16. Accordingly, M=N−4 bits. Table 2 below shows an increment of the frame counter value in an inside block-based nonce (such as nonce 800) if the secured frame is transmitted or received in the first slot of different rounds in 3 consecutive blocks. It can be seen that the frame counter value increment by 273 every time the block index updates. For example, for a block structure with 96 ms block duration, the frame counter will wrap around in about 3,435,974 minutes.

TABLE 2

| Block Index | Round Index | Slot Index | Frame Counter |
|---|---|---|---|
| (31 bits) | (4 bits) | (4 bits) | (F.C.) Value |
| 0x00000000 | 0x0 | 0x1 | 1 |
| 0x00000001 | 0x1 | 0x1 | 273 |
| 0x00000002 | 0x7 | 0x1 | 625 |

By comparing Table 2 with Table 1, it can be seen that a rapid increment of the frame counter value can be prevented if a nonce 800 is used. Accordingly, there is no need to update a security key so frequently.

Alternatively, it is also possible to achieve the same effect for the construction of the frame counter (FC) field of the Nonce in FIG. 8 without segmenting the FRAME COUNTER field into slot index, round index and block index fields (such as 822-824) by defining the value (i.e., FC) of the frame counter field as Equation (3):

$$FC = Block\_Index \times NumRounds \times NumSlots + Round\_Index \times NumSlots + Slot\_Index \qquad ( 3 )$$

In Equation (3), Block_index, Round_Index, and Slot_Index refer to the block index, round index, and slot index respectively.

It is also possible that the Nonce in FIG. 8 could have the same format as the Nonce in FIG. 6B, i.e., the frame counter field is 4 octets long and the nonce includes the nonce security level field.

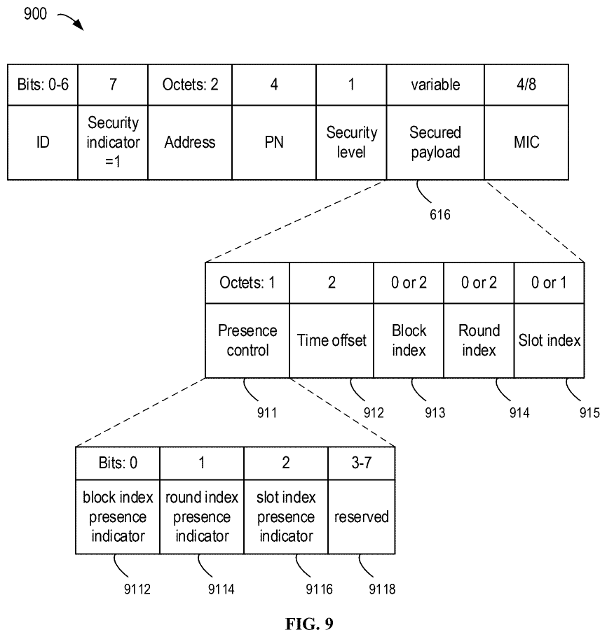

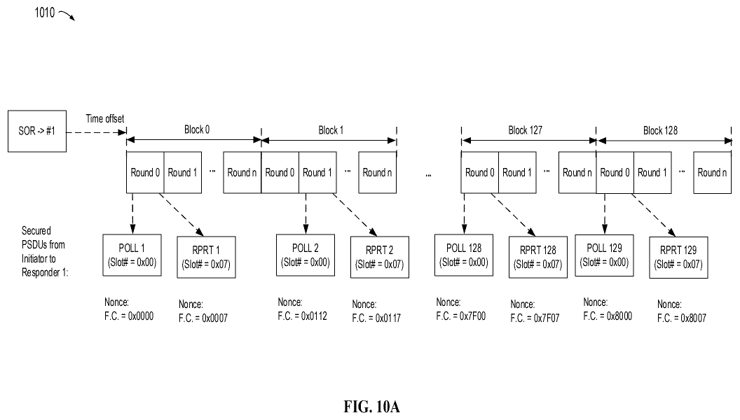

FIG. 9 illustrates a schematic diagram of a format of a secured SOR frame 900 in accordance with some example embodiments of the present disclosure. Similar with that described in FIG. 6A, the secured SOR frame 900 includes a field 616 carrying secured payload.

The field 616 includes a field 911 which is a presence control field, a field 912 carrying a time offset, a field 913 carrying a block index, a field 914 carrying a round index and a field 915 carrying a slot index. The field 911 may include a field 9112 carrying a block index presence indicator, a field 9114 carrying a round index presence indicator, a field 9116 carrying a slot index presence indicator, and a reserved field 9118.

In case the controller assigns a controlee to an existing block structure, the block, round, slot indices pointed by the time offset field of the SOR frame may not start from zero. If the POLL frame transmitted at the time pointed by the time offset field of the SOR frame does not carry the indices of the round and block in the open payload (as shown in FIG. 7A), i.e., if the indices are encrypted; the responder will not be able to unsecure the POLL frame since it will not be able to construct the nonce. When indicating the first round allocated to a controlee, in addition to the time offset in field 912 to the allocated block/round, if the controller also included the indices of the block, round and slot that is pointed by the time offset field 912, e.g., in the field 616 of the secured SOR frame 900. This will enable the first frame (e.g., POLL frame) transmitted in the block, round and slot pointed by the time offset field 912 to be encrypted.

In some other examples, if any of the block index presence indicator in field 9112, the round index presence indicator in field 9114, the slot index presence indicator in field 9116 indicates the corresponding index is not included, then a default index (such as zero) may be applied.

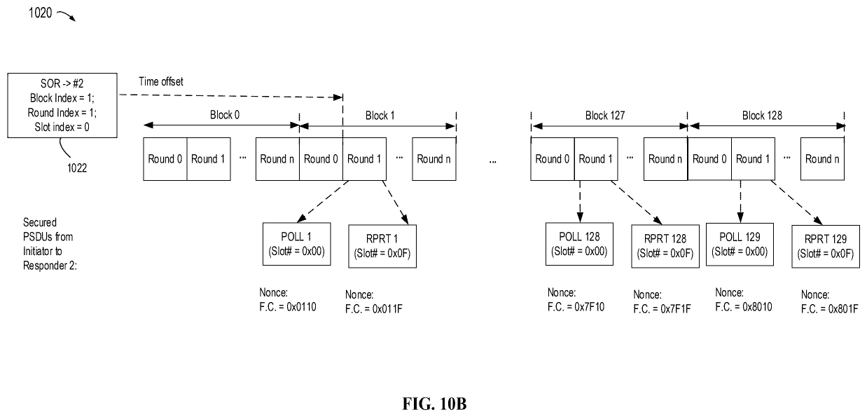

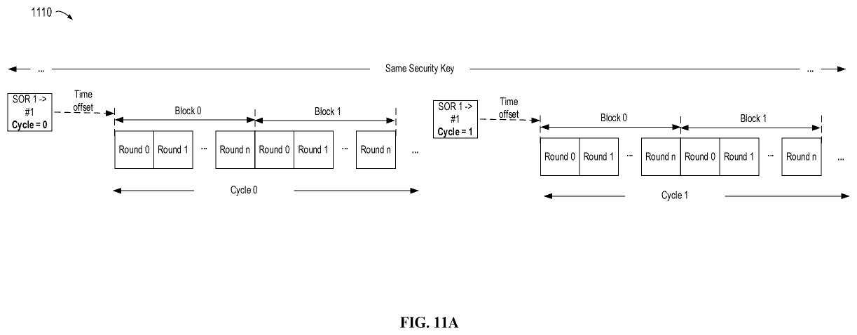

FIG. 10A illustrates an example session 1010 of the initiator 260 with a responder 1 (such as the responder 270-1) in accordance with some example embodiments of the present disclosure. FIG. 10B illustrates an example session 1020 of the initiator 260 with a responder 2 (such as the responder 270-2) in accordance with some example embodiments of the present disclosure. In both examples, the quantity of rounds per block (NumRounds)=16; and the quantity of slots per round (Numslots)=16. This leads to the quantity of bits for round index (N)=the quantity of bits for slot index (M)=4. The frame counter field used to construct the nonce for securing/unsecuring each frame is shown below the frame, for example “Nonce: F.C.= . . . ”.

As shown in FIG. 10A, the SOR frame to the responder 1 may be a secured SOR frame as shown in FIG. 6A, as such, the responder 1 will assume the slot index, the round index, and the block index are all 0. Accordingly, the first POLL frame (POLL 1) to responder 1 is transmitted in slot 0 (0x0) of round 0 of block 0 and the least significant two octets (in hexadecimal) of the frame counter field used to construct the nonce for securing/unsecuring the POLL 1 frame can be calculated to be 0x0000. Similarly, the 128th RPRT frame (RPRT 128) is transmitted in slot 7 (0x7) of round 0 (0x0) of block 127 (0x7F) and the least significant two octets (in hexadecimal) of the frame counter field used to construct the nonce for securing/unsecuring the RPRT 128 frame can be calculated to be 0x7F07.

As shown in FIG. 10B, the SOR frame to the responder 2 may be a secured SOR frame as shown in FIG. 9, as such, the responder 2 will be aware the existing block-based time structure and the indices of the slot, round and block where the first POLL frame is expected by unsecuring the secured SOR frame, e.g., “block index=1, round index=1, slot index=0” shown at 1022. Accordingly, the first POLL frame to responder 2 (POLL 1) is transmitted in slot 0 of round 1 of block 1 and the least significant two octets (in hexadecimal) of the frame counter field used to construct the nonce for securing/unsecuring the POLL 1 frame can be calculated to be 0x0110. Similarly, the 129th RPRT frame (RPRT 129) is transmitted in slot 15 (0xF) of round 1 (0x1) of block 128 (0x80) and the least significant two octets (in hexadecimal) of the frame counter field used to construct the nonce for securing/unsecuring the RPRT 129 frame can be calculated to be 0x801F.

It is assumed that the indices of the block, the round, and the slot structure are always incrementing and the block structure is never restarted within the same session between a pair of an initiator and a responder, while constructing an inside block nonce, such as nonce 720 or nonce 800. In case that the block structure is restarted two or more times between the same pair of the initiator and the responder, if a same security key is used to secure the frames, then the inside block nonce may repeat which may be a security violation.

In some embodiments, in case the block structure is restarted, the security key should be updated. In other words, every time a new block structure is setup between a same pair of the initiator and the responder, a new security key shall be used.

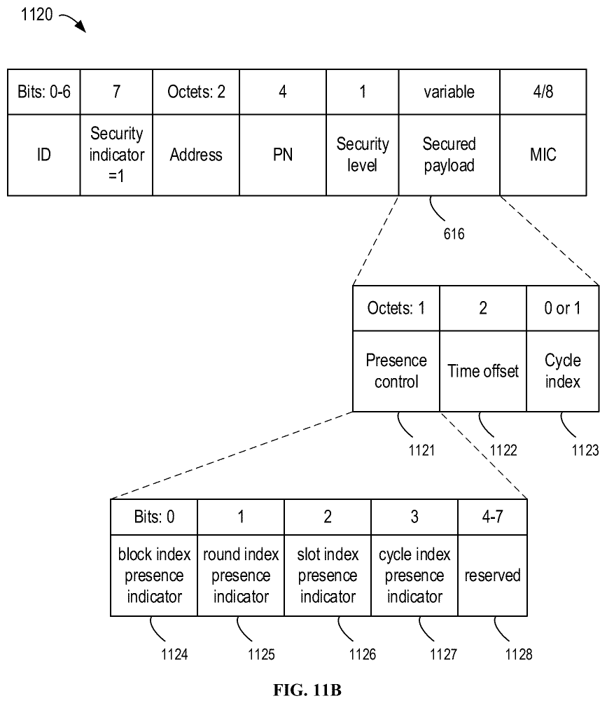

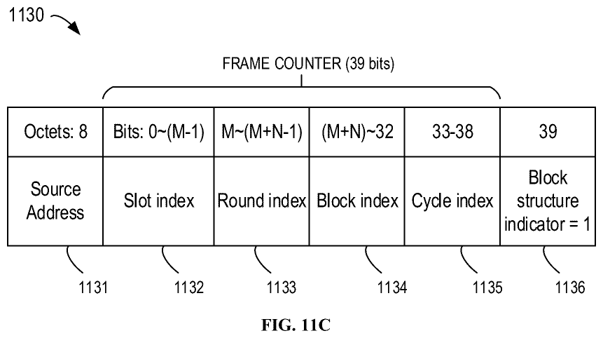

In some other embodiments, a cycle may be defined to avoid an occurrence of this case, where a cycle includes multiple blocks. In other words, a layer on top of block may be added: cycle. An index of the cycle may be incremented every time the block structure is restarted between a same pair of the initiator and the responder, while the security key is unchanged. FIG. 11A illustrates a schematic diagram of a time structure 1110 including a cycle in accordance with some example embodiments of the present disclosure. As shown in FIG. 11A, two cycles, cycle 0 and cycle 1, are shown.

If a cycle is newly defined, an index of cycle in which the secured frame is transmitted in may be also used to construct the inside block nonce. For example, an inside block nonce may be constructed based on a slot index, a round index, a block index, and a cycle index.

FIG. 11B illustrates a schematic diagram of a format of another secured SOR frame 1120 in accordance with some example embodiments of the present disclosure. Similar with that described in FIG. 9, the secured SOR frame 11200 includes a field 616 carrying secured payload.

The field 616 includes a field 1121 which is a presence control field, which includes a field 1124 carrying a block index presence indicator, a field 1125 carrying a round index presence indicator, a field 1126 carrying a slot index presence indicator, a field 1127 carrying a cycle index presence indicator, and a reserved field 1128.

The fields 1124-1126 may be similar with the fields 9112-9116 in FIG. 9, and thus will not be described in detail herein. In FIG. 11B, it is assumed that the fields 1124-1126 indicate that there is no block index field, round index field, or slot index field, thus there is no fields in FIG. 11 B corresponding to fields 913-915 in FIG. 9.

The field 1127 carrying a cycle index presence indicator which may indicate whether a field 1123 is included. As shown in FIG. 11B, the field 616 includes a field 1122 carrying a time offset and field 1123 carrying a cycle index.

Alternatively, if the block index presence indicator in field 1124 is 1, a block index field carrying the block index may be further included, similar with the field 913 in FIG. 9. If the round index presence indicator in field 1125 is 1, a round index field carrying the round index may be further included, similar with the field 914 in FIG. 9. If the slot index presence indicator in field 1126 is 1, a slot index field carrying the slot index may be further included, similar with the field 915 in FIG. 9. In other words, the secured payload 616 may include a presence control field (such as field 911 or 1121), a field carrying the time offset (such as field 912 or 1122), and may further include zero or more of a block index field, a round index field, a slot index field, and a cycle index field without a limitation of an order. For example, the field carrying the time offset (such as field 912 or 1122) may be located at the end of the field 616, i.e., the last two octets.

In some examples, the initiator 260 may use the secured SOR frame 1120 to inform the cycle index to the responder 270 every time a new block structure is started, in order to allow the responder to synchronize with the cycle index.

FIG. 11C illustrates a schematic diagram of another format of a nonce 1130 for securing a frame inside block structure in accordance with some example embodiments of the present disclosure. Alternatively, the nonce 1130 may be called as an inside block-based nonce.

As shown in FIG. 11C, the nonce 1130 includes a frame 1131 carrying a source address, a field 1132 carrying a slot index, a field 1133 carrying a round index, a field 1134 carrying a block index, a field 1135 carrying a cycle index, and a field 1136 carrying a block structure indicator. It is noted that the nonce 1130 is similar with the nonce 800 in FIG. 8, with a difference that the field 824 in FIG. 8 is split into the field 1134 and the field 1135 in FIG. 11C. For example, some of the MSBs of the block index field may be allocated for the cycle index, such as 6 bits allowing up to 64 cycles.

Alternatively, the nonce 1130 may include a field carrying a security level, which is similar with the field 624 in FIG. 6B. Alternatively, the field 1135 may be split into two fields, one of which carrying the cycle index and the other one being reserved. In some examples, an order of the fields 1132-1135 may be in another way, such as an inverse order as show in FIG. 11C.

According to some embodiments described above with reference to FIGS. 4-9, some secured frame may include a field carrying PN, such as the SOR frame 610 or 900. Table 3 below lists some frames, some of which may need to include a PN while some others may not need to include a PN.

TABLE 3

| | | Includes a | Nonce | Block Structure |
|---|---|---|---|---|
| | | PN field | (Outside or Inside | Indicator |
| frame | ID | (Yes or No) | Block-based) | (0 or 1) |
| POLL | 0x00 | No | Inside block-based | 1 |
| RESP | 0x01 | No | Inside block-based | 1 |
| RPRT | 0x02 | No | Inside block-based | 1 |
| RPRT | 0x03 | No | Inside block-based | 1 |
| PRM-RESP | 0x04 | No | Inside block-based | 1 |
| PRM-REQ | 0x05 | No | Inside block-based | 1 |
| ADV-HBS | 0x06 | No | Inside block-based | 1 |
| | | . . . | | |
| ADV-POLL | 0x20 | Yes | Outside block-based | 0 |
| ADV-RESP | 0x21 | Yes | Outside block-based | 0 |
| SOR | 0x22 | Yes | Outside block-based | 0 |

Further, the frames transmitted outside the block structure (e.g., ADV-POLL, ADV-RESP, SOR) include the PN field in the frame and use the outside block-based Nonce (nonce 620 as shown in FIG. 6B), while the frames transmitted inside the block structure (e.g., POLL, RESP, RPRT, PRM-RESP, PRM-REQ, ADV-HBS) do not include the PN field in the frame and use the inside block-based Nonce (such as nonce 720 as shown in FIG. 7B, or a nonce 800 as shown in FIG. 8).

In some examples, the operation of securing a frame may also be referred to as an AEAD transformation, and the operation of unsecuring a secured frame may also be referred to as an AEAD inverse transformation, the present disclosure does not limit this aspect.

Although some embodiments described above with reference to FIGS. 4-11C are related to the block-based time structure, it is to be understood that they may also be related to the hyper block-based time structure.

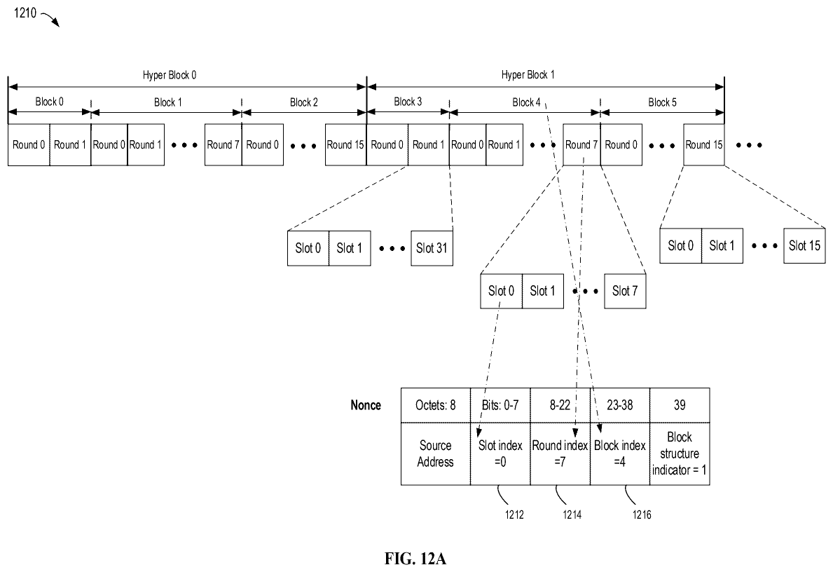

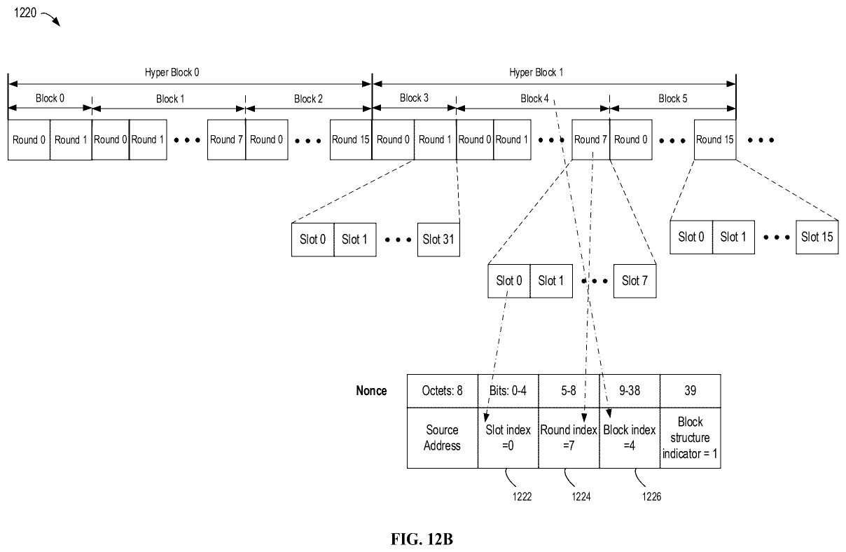

FIG. 12A illustrates a schematic diagram 1210 of a nonce construction in a hyper block-based time structure in accordance with some example embodiments of the present disclosure. As shown in FIG. 12A, a hyper block is composed of three types of blocks: block 0 including 2 rounds each with 32 slots, block 1 including 8 rounds each with 8 slots, and block 2 including 16 rounds each with 16 slots. If a frame is transmitted in slot 0 of round 7 or block 4, then the nonce may include a field 1212 carrying “slot index=0”, a field 1214 carrying “round index=7”, and a field 1216 carrying “block index=4”. The nonce in FIG. 12A may be an inside block nonce based on the nonce 720, in which the lengths of fields 1212-1216 are fixed.

FIG. 12B illustrates a schematic diagram 1220 of a nonce construction in a hyper block-based time structure in accordance with some example embodiments of the present disclosure. Similar to FIG. 12A, a hyper block is composed of three types of blocks: block 0 including 2 rounds each with 32 slots, block 1 including 8 rounds each with 8 slots, and block 2 including 16 rounds each with 16 slots. If a frame is transmitted in slot 0 of round 7 or block 4, then the nonce may include a field 1222 carrying “slot index=0”, a field 1224 carrying “round index=7”, and a field 1226 carrying “block index=4”.

The nonce in FIG. 12B may be an inside block nonce based on the nonce 800, in which the lengths of fields 1222-1226 are not fixed. Further, the maximum number of slots in a round (Max_NumSlots)=max (32, 8, 16)=32, thus M can be determined as 5. Thus the length of the field 1222 is 5 bits. Further, the maximum number of rounds in a block (Max_NumRounds)=max (2, 8, 16)=16, thus N can be determined as 4. Thus the length of the field 1224 is 4 bits.

Therefore, a PN may be used for constructing an outside block nonce, a slot index, a round index, and a block index (and optional a cycle index) may be used for constructing an inside block nonce, the frames transmitted between the initiator and the responder may be secured accordingly, and thus the communication security can be guaranteed.

Alternatively, it is also possible to achieve the same effect for the construction of the frame counter field of the nonce in FIG. 12A without segmenting the frame counter field into slot index, round index and block index fields by defining the value (i.e., FC) of the frame counter field as Equation (4):

$$FC = Block\_Index \times Max\_NumRounds \times Max\_NumSlots + Round\_Index \times Max\_NumSLots + Slot\_Index \qquad ( 4 )$$

In Equation (4), Block_index, Round_Index and Slot_Index refer to the block index, round index and slot index respectively. In the event that the block index in a hyper block are represented as relative block index, the block index can be calculated as Equation (5):

$$Block\_Index = Hyper\_Block \_Index \times NumBlocks + Relative\_Block \_Index \qquad ( 5 )$$

In Equation (5), Hyper Block_Index is the index of the hyper block, Relative Block_Index is the relative block index and NumBlocks is the quantity of blocks in a hyper block.

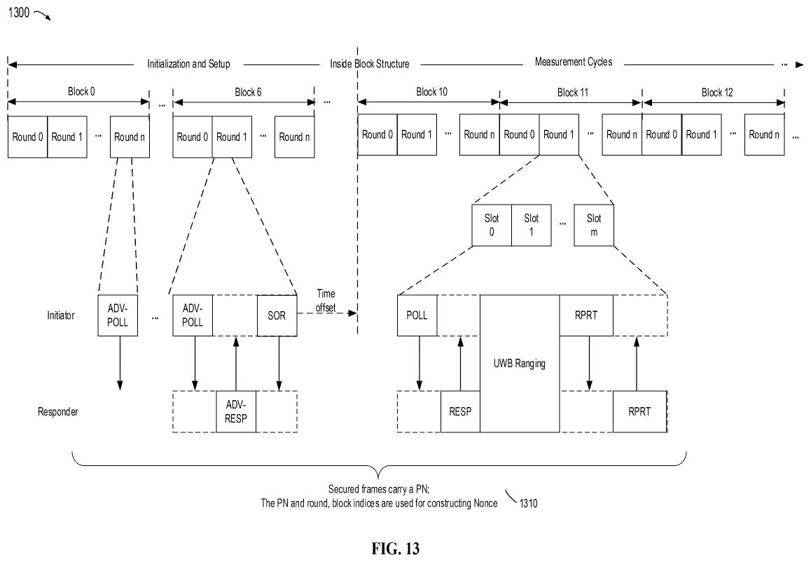

FIG. 13 illustrates a schematic diagram of another example MMS ranging session 1300 in a block-based time structure in accordance with some example embodiments of the present disclosure. As shown in FIG. 13, the MMS ranging session 1300 includes an initialization and setup phase followed by one or more measurement cycles.

In FIG. 13, it is assumed that the block structure exists during the initialization and setup phase too. For example, the controller may set up the block structure right at the beginning (i.e., even prior or at the start) of the initialization and setup phase. As such, both the initialization and setup phase and the one or more measurement cycles are inside block structure.

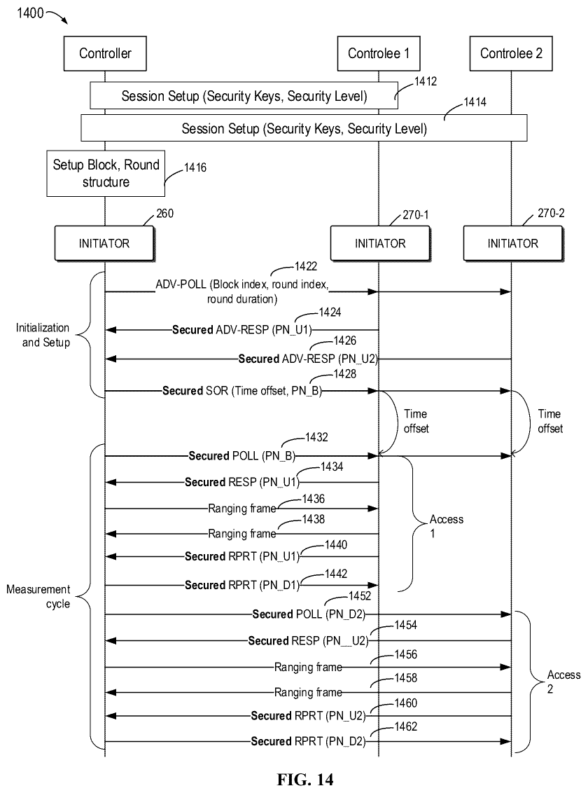

Since a synchronization between an initiator 260 and a responder 270 at the slot level may be not easy during the initialization and setup phase, the slot index is not used for constructing the nonce, however, a short PN (e.g., 1 octet long) may be used. In this case, a PN, a round index, and a block index can be used for constructing a nonce which is used for securing a frame, as shown at 1310. Since a round index is used, it is suggested that the initialization and setup phase should be completed within one round in order to prevent a loss of the synchronization due to change in the round indices. FIG. 14 illustrates a signalling chart illustrating a process 1400 of another example MMS ranging session in accordance with some example embodiments of the present disclosure.

The process 1400 begins with a controller and two controlees performing a session setup 1412 and a session setup 1414 respectively. During the session setup 1412/1414, long-term session parameters such as a UWB channel number, preamble codes, a block structure (such as number of blocks, block durations) etc. are negotiated. When security is enabled, at least one security key will also be provided by the controller to each controlee to secure unicast frame (i.e., frames that are exchanged between the responder and the initiator). If security is enabled for broadcast frames as well, then a separate security key common to all responders are also provided. For an NBA-MMS ranging session, parameters related to narrow band (such as NB channel number, number of MMS fragments, etc.) may also be negotiated during the session setup 1412/1414. While FIG. 13 shows the same block structure being used for the initialization and setup phase as well as the measurement cycles, it is also possible that different block structures may be used for the initialization and setup phase and the measurement cycles. In such a case, one security key may also be negotiated for the initialization and setup phase and a different security key negotiated for the measurement cycles. In this case the PN spaces will also be different for the initialization and setup phase and the measurement cycles. Also, the block index of the block structure for the measurement cycles may start from zero at the time pointed by the time offset of the SOR frame.

Some other parameters such as number of MMS fragments, report mode etc. may be considered short term parameters since they may be modified during the MMS ranging session. The session setup 1412/1414 may be performed out-of-band, for example using BLUETOOTH or Wi-Fi radio, or may also be performed in-band, for example using narrow band or UWB radio.

Additionally, the roles of initiator and responder are also assigned during the session setup 1412/1414. As a specific example shown in FIG. 14, it is assumed that the controller takes the role of initiator 260 and the controlees are assigned the role of responders 270-1 and 270-2. However, it is to be understood that it is also possible that the controlee may be assigned the role of initiator while the controller assumes the role of responder.

At 1416, the controller (initiator 260) starts the block structure prior a transmission of the first ADV-POLL frame. For example, the initiator 260 may setup the block and round structure, e.g., with at least the block duration and the round duration defined. In some cases, it is possible that the slot structure is also defined, in which case the slot index can be used instead of the PN for the nonce construction, both inside or outside the block structure.

At 1422, the initiator 260 transmits the ADV-POLL frames opportunistically at times and intervals to its discretion while the responders 270-1 and 270-2 may opportunistically listen for incoming ADV-POLL frames. In order to allow the responders 270-1 and 270-2 to synchronize with the block structure, the ADV-POLL frame includes the indices of the round and block in which the ADV-POLL frame is transmitted, as well as the duration of the current round. If the slot structure is also defined, the ADV-POLL frame also includes a slot index of the slot in which the ADV-POLL frame is transmitted.

At 1424, the responder 270-1 responds with the ADV-RESP frame if the responder 270-1 intends to participate in a ranging session with the initiator 260. If security is enabled, the ADV-RESP frame carries a PN (e.g., PN_U1) that is used to construct the nonce for securing the ADV-RESP frame. As shown in FIG. 14, a secured ADV-RESP frame may be transmitted from the responder 270-1 to the initiator 260.

At 1426, the responder 270-2 responds with the ADV-RESP frame if the responder 270-2 intends to participate in a ranging session with the initiator 260. If security is enabled, the ADV-RESP frame carries a PN (e.g., PN_U2) that is used to construct the nonce for securing the ADV-RESP frame. As shown in FIG. 14, a secured ADV-RESP frame may be transmitted from the responder 270-2 to the initiator 260.

At 1428, once the initiator 260 has received the ADV-RESP frames, it transmits the SOR frame that provides a time offset at which the first range-measurement cycle will start. The SOR frame may be transmitted broadcast, so that both the responder 270-1 and the responder 270-2 may detect it. If security is enabled, the SOR frame carries a broadcast PN (e.g., PN_B) that is used to construct the nonce used for securing the SOR frame. As shown in FIG. 14, a secured SOR frame may be transmitted from the initiator 260 to the responders 270-1 and 270-2. It is to be noted that different number spaces may be used for the PN for unicast and broadcast frames. In this case the time offset field in the SOR frame points to the time at which the first POLL frame is transmitted. Alternatively, it is also possible that the SOR frame carries multiple time offset fields, one for each responder; or the initiator may transmit multiple unicast SOR frames, one for each responder; and the time offset fields pointing to the exact time at which the ranging measurement cycle is to begin for a particular responder.

At 1432, the initiator 260 transmits a broadcast POLL frame to the responders 270-1 and 270-2 at the beginning of the first slot of a round, where the beginning of the first slot is indicated by the time offset in the SOR frame. The initiator 260 may also include other control information in the POLL frame for the responders 270-1 and 270-2.

At 1434, the responder 270-1 transmits a RESP frame back to the initiator 260 in case it receives the POLL frame successfully. The POLL and RESP frames allow the initiator 260 and responder 270-1 to achieve a time and frequency synchronization.

In the ranging phase, the initiator 260 and the responder 270-1 may exchange zero or more UWB RSFs and optionally one or more UWB RIFs. The RSFs are used to perform ranging measurements while the RIFs are used to check the integrity of the ranging measurements. Illustratively, the exchanging between the initiator 260 and the responder 270-1 is shown at 1436 and 1438 in FIG. 14.

After the initiator 260 or the responder 270-1 completes the reception of all UWB fragments for the ranging phase, a report phase may start. During the report phase, the initiator 260 or the responder 270-1 may generate a ranging measurement report, and send an RPRT frame carrying the measurement report to the peer device. As shown in FIG. 14, the initiator 260 sends a secured RPRT frame to the responder 270-1 at 1440, while the responder 270-1 sends a secured RPRT frame to the initiator 260 at 1442.

The process 1452-1462 between the initiator 260 and the responder 270-2 is similar with the process 1432-1442 between the initiator 260 and the responder 270-1, and thus will not repeat herein.

As shown in FIG. 14, each of all secured frames carries an appropriate PN. The PN, together with the indices of the round and the block may be used to construct the nonce for securing the POLL, RESP, and RPRT frames.

Some example formats of frames and nonce are shown in the present disclosure with reference to drawing. However, it should be noted that the examples are given for the purpose of illustration without suggesting any limitations to the present disclosure. For example, a frame or nonce may include multiple fields, one or more fields may be omitted in some cases, one or more un-shown fields may further included. For example, two or more fields may be combined as one field. For example, one field may be replaced by one or more different fields. For example, a field carrying information may be split into two fields, one field carrying the information and the other one field being reserved. For example, each length (in unit of octets or bits) may be a fixed value or an adjusted value. For example, an arrangement of the fields may be in another way, e.g., in a different order. The present disclosure does not limit this aspect.

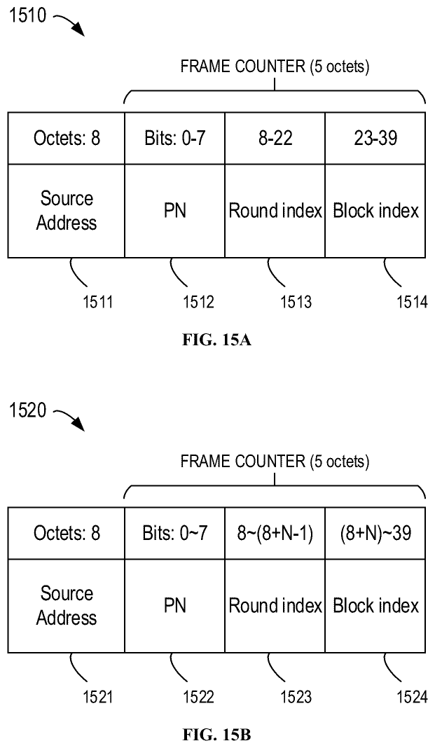

FIG. 15A illustrates a schematic diagram of a format of a nonce 1510 for securing a frame in accordance with some example embodiments of the present disclosure. For example, the nonce 1510 may be constructed by the initiator 260 or the responder 270-1 or 270-2.

As shown in FIG. 15A, the nonce 1510 includes a frame 1511 carrying a source address, a field 1512 carrying a PN, a field 1513 carrying a round index, and a field 1514 carrying a block index.

The field 1511 may indicate an extended address of the device originating the frame. The fields 1512-1514 may be considered as a frame counter the nonce 720.

A length of the field 1512 carrying the PN may be 1 octet, i.e., 8 bits. The PN may also be called as a short PN. For example, the PN starts from 0 in every round and shall not wrap around in a round. It is to be understood that the maximum number of secured frames per round depends on the length of the field 1512, for example the maximum number of secured frames per round is 256 if the field 1512 occupies 8 bits.

As shown in FIG. 15A, the length of the field 1513 is fixed, such as 15 bits (8-22). In some other examples, the length of the field carrying the round index may not be a fixed value. FIG. 15B illustrates a schematic diagram of another format of nonce 1520 which includes a frame 1521 carrying a source address, a field 1522 carrying a PN, a field 1523 carrying a round index, and a field 1524 carrying a block index. A length of the field 1523 is N bits, where N may be determined by Equation (2) described above.

Alternatively, the nonce 1510 or 1520 may include a field carrying a security level, which is similar with the field 624 in FIG. 6B. Alternatively, the field 1514 or 1524 may be split into two fields, one of which carrying the block index and the other one being reserved. In some examples, an order of the fields 1512-1514 or 1522-1524 may be in another way, such as an inverse order as show in FIG. 15A or FIG. 15B.

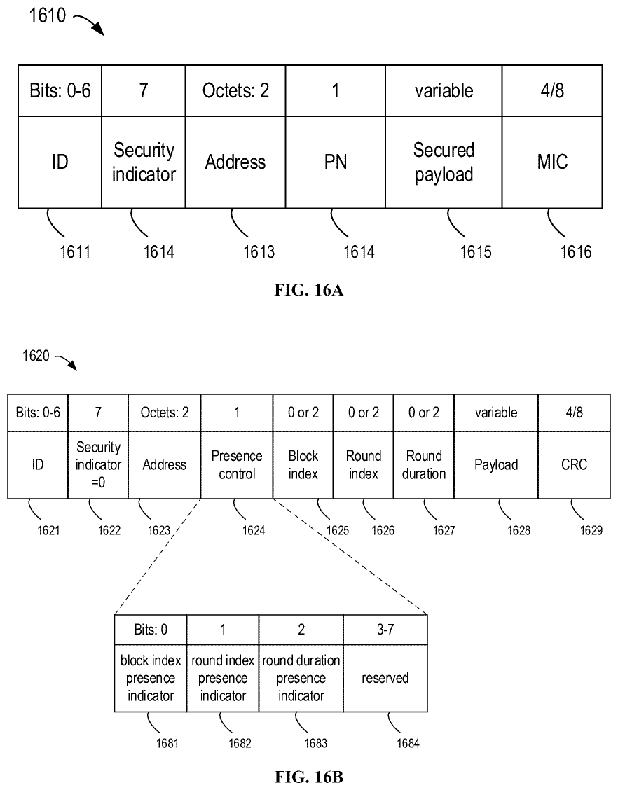

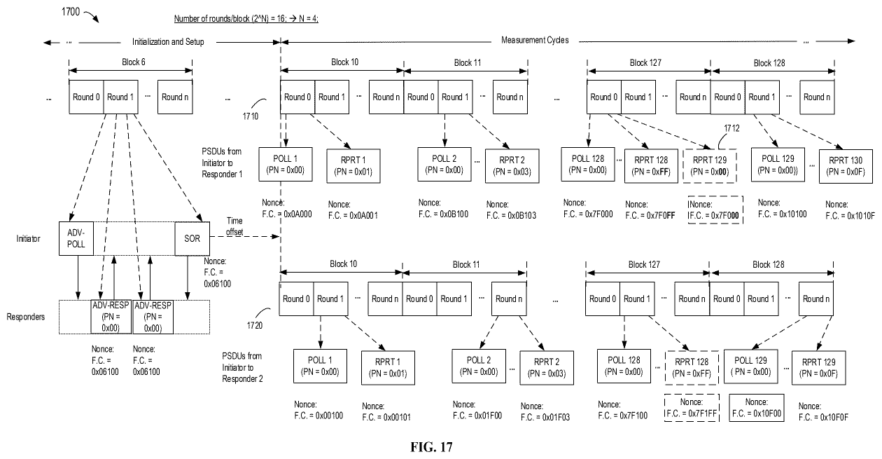

FIG. 16A illustrates a schematic diagram of a format of a secured RPRT frame 1610 in accordance with some example embodiments of the present disclosure. For example, the secured RPRT frame 1610 may be any of frames transmitted at 1440, 1442, 1460, and 1462 in FIG. 14.

As shown in FIG. 16A, the secured RPRT frame 1610 includes a field 1611 carrying an ID, a field 1612 carrying a security indicator, a field 1613 carrying an address, a field 1614 carrying a PN, a field 1615 carrying a secured payload, and a field 1616 carrying the MIC. The fields 1611-1614 may be considered as a CHR of the secured RPRT frame 1610. Although the RPRT frame 1610 is shown in the compressed PSDU format, the procedure described works even if the frame is carried as a compressed header ID format or even as a 802.15.4 frame.

The field 1611 may indicate an identity of the secured RPRT frame 1610. The field 1612 may indicate whether the frame is secured. In some examples, the field 1612 carrying “1” indicates that the frame is secured. As shown in FIG. 16A, a total length of the field 1611 and the field 1612 may be 1 octet.

The field 1614 may carry a packet number of the secured RPRT frame 1610. With reference with FIG. 14, PN_U1 may be maintained for an uplink transmission from the responder 270-1 to the initiator 260, and PN_D1 may be maintained for a downlink transmission from the initiator 260 to the responder 270-1. PN_U2 may be maintained for an uplink transmission from the responder 270-2 to the initiator 260, and PN_D2 may be maintained for a downlink transmission from the initiator 260 to the responder 270-2. As shown in FIG. 16A, a length of the field 1614 may be 1 octet.

The field 1615 carries secured payload. The field 1616 carries the MIC generated by an AEAD transformation process. A length of the field 1616 may be 4 octets or 8 octets.

Alternatively, the secured RPRT frame 1610 may include a field carrying a security level, which is similar with the field 615 in FIG. 6A.

FIG. 16B illustrates a schematic diagram of a format of an ADV-POLL frame 1620 in accordance with some example embodiments of the present disclosure. For example, the ADV-POLL frame 1620 may be a frame transmitted at 1422 in FIG. 14.

As shown in FIG. 16B, the ADV-POLL frame 1620 includes a field 1621 carrying an ID, a field 1622 carrying a security indicator, a field 1623 carrying an address, a field 1624 which is a presence control field, a field 1625 carrying a block index, a field 1626 carrying a round index, a field 1627 carrying a round duration, a field 1628 carrying a payload, and a field 1629 carrying the CRC. The fields 1621-1623 may be considered as a CHR of the ADV-POLL frame 1620, and the fields 1624-1627 may be considered as open payload of the ADV-POLL frame 1620.

The field 1621 may indicate an identity of the ADV-POLL frame 1620. The field 1622 may indicate whether the ADV-POLL frame 1620 is secured. In some examples, the field 1622 carrying “0” indicates that the ADV-POLL frame 1620 is unsecured. As shown in FIG. 16B, a total length of the field 1621 and the field 1622 may be 1 octet.

The field 1624 includes a block index presence field 1681 carrying a block index presence indicator, a round index presence field 1682 carrying a round index presence indicator, a round duration presence field 1683 carrying a round duration presence indicator, and a reserved field 1684. As shown in FIG. 16B, a length of the field 1624 may be 1 octet.

In some examples, the block index presence indicator equals to a first value (such as 1) to indicate that a presence of the block index field 1625, the round index presence indicator equals to a first value (such as 1) to indicate that a presence of the round index field 1626, and the round duration presence indicator equals to a first value (such as 1) to indicate that a presence of the round duration field 1627. For example, a length of each of the fields 1625-1627 may be 2 octets.

Alternatively, the secured ADV-POLL frame 1620 may include a field carrying a security level, which is similar with the field 615 in FIG. 6A. Alternatively, an order of the fields 1625-1627, an order of the fields 1681-1683 are not limited in the present disclosure.

Since the ADV-POLL frame 1620 is transmitted at the beginning of a round and includes the block structure information (such as the block index, the round index, the round duration in fields 1625-1627), the initiator and the responder(s) can synchronize to the block structure during the initialization and setup phase.

FIG. 17 illustrates an example session 1700 of the initiator 260 with a responder 1 (such as the responder 270-1) and a responder 2 (such as the responder 270-2) in accordance with some example embodiments of the present disclosure. It is assumed that the nonce 1520 shown in FIG. 15B is used. As a specific example, it is assumed that each block includes 16 rounds, i.e., NumRounds=16, thus N=4 can be determined.

Downlink secured frames from the initiator to responder 1 are shown at 1710, while downlink secured frames from the initiator to responder 2 are shown at 1720. The frame counter field used to construct the nonce for securing/unsecuring each frame is shown below the frame.

As shown in FIG. 17, both ADV-RESP frames from responder 1 and responder 2 are secured frame transmitted in round 1 of block 6 and the PN fields in both frames may be set as zero (i.e., PN=0x00 as shown in FIG. 17). The least significant 20 bits (in hexadecimal) of the frame counter fields used to construct the nonce for securing/unsecuring the ADV-RESP frames can be calculated to be 0x06100. Although the FC for both ADV-RESP frames are same, since the source address field in the nonce are different and the security keys used for responder 1 and responder 2 are different, this is not a security violation. Similarly, the 128th RPRT frame (RPRT 128) with a PN field set to 0xFF is transmitted to responder 1 in round 0 (0x0) of block 127 (0x7F) and the least significant 20 bits (in hexadecimal) of the frame counter field used to construct the nonce for securing/unsecuring the RPRT 128 frame can be calculated to be 0x7F0FF.

A potential wrap around of the PN field in the RPRT frame is also shown at 1712 within block 127. If the wrap around of the PN field occurs within the same round, this will cause the frame counter (0x7F000) to repeat (same as that used for the POLL frame (POLL 128) and leads to the reuse of the Nonce. However, as long as a limit of maximum 256 frames per device per round limit is observed, the frame counter will not repeat and this issue can be averted.

Alternatively, it is also possible to achieve the same effect for the construction of the frame counter field of the nonce in FIG. 15A or FIG. 15B without segmenting the frame counter field into PN, round index and block Index fields by defining the value (i.e., FC) of the frame counter field as Equation (6):

$$FC = Block\_Index \times NumRounds \times {2}^{M} + Round\_Index \times {2}^{M} + PN \qquad ( 6 )$$

In Equation (6), Block_index and Round_Index refer to the block index and round index respectively, and M=the quantity of bits used for the PN field.

According to some embodiments with reference to FIGS. 3-17, a block index, a round index, and a slot index/a PN may be used for constructing a nonce, where the nonce may be used to securing a frame or unsecuring a secured frame which is transmitted based on a block-based time structure or a hyper block based time structure, as such, an AEAD security operation may be applied and the security communication between an initiator and a responder can be guaranteed.

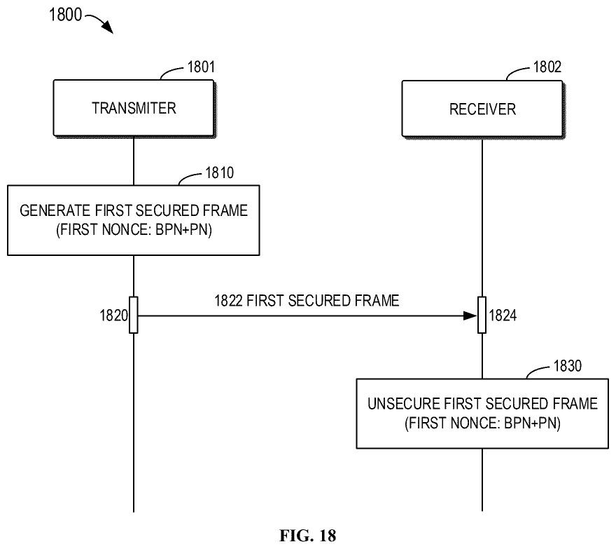

Reference is further made to FIG. 18, which illustrates a signaling chart illustrating communication process 1800 in accordance with some example embodiments of the present disclosure. The process 1800 may involve a transmitter 1801 and a receiver 1802. It is understood that the transmitter 1801 may be the controller 210 or the controlee 220, and the receiver 1802 may be the controlee 220 or the controller 210, with reference to FIG. 2A. It is understood that the transmitter 1801 may be the initiator 260 or the responder 270, and the receiver 1802 may be the responder 270 or the initiator 260, with reference to FIG. 2B.

The transmitter 1801 generates 1810 a first secured frame. The first secured frame may be secured by a first nonce, where the first nonce is constructed based on a first base packet number (BPN) and a first PN. In some embodiments, the transmitter 1801 may construct the first nonce, and then generate the first secured frame.

The first BPN is associated with an initiator and a responder. Further, the first BPN is associated with a communication direction from the transmitter 1801 to the receiver 1802. For example, if the transmitter 1801 is the initiator 260, the first BPN is a DL BPN; if the transmitter 1801 is the responder 270, the first BPN is a DL BPN. The first PN is a packet number of the first secured frame.

The first nonce includes a first field carrying the first BPN and a second field carrying the first PN. A length of the first field may equal to a first quantity, such as NI bits. A length of the second field may equal to a second quantity, such as N2 bits. For example, a total number of the first quantity and the second quantity may be a predefined value, such as 40 bits. The initial value of the first BPN may be locally stored in the transmitter 1801 and may be indicated to the receiver 1802, e.g., during the session setup etc. and locally stored in the receiver. Alternatively, a default value (e.g., 0) may be used as the initial value of the first BPN.

The first nonce includes a source address. For example, the first nonce may include a field carrying the source address, e.g., a source address field. A length of the field carrying the source address may be predefined, such as 8 octets, 7 octets, or another value.

In some example embodiments, the first secured frame is to be transmitted during an initialization and setup phase or during a measurement cycle. In some examples, the first secured frame may include the first BPN and the first PN. In some other examples, the first secured frame may include the first PN without the first BPN, in this case, a locally stored first BPN may be used.

The first secured frame may include a first security indicator. For example, the first secured frame may include a field carrying the first security indicator, e.g., a security indicator field. The first security indicator may indicate whether the first secured frame is secured. For example, the first security indicator may be “1” indicating that the first secured frame is secured. For example, a length of the field carrying the first security indicator is 1 bit.

The first secured frame includes a first PN field carrying the first PN. A length of the first PN field may be a predefined value, such as 1 octet.

The first secured frame may include a BPN presence field carrying a BPN presence indicator. The BPN presence indicator may indicate whether a BPN field is included. For example, the BPN presence indicator is “1” indicating a presence of the BPN field. The first secured frame may include a BPN field carrying the first BPN, allowing the receiver to obtain the BPN to be used for unsecuring the frame as well as subsequent secured frames transmitted by the same initiator. In some examples, if the first BPN equals to a default number (such as 0), the BPN presence indicator may be “0” indicating that there is no BPN field included.

The transmitter 1801 sends 1820 the first secured frame 1822 to the receiver 1802. And the receiver 1802 receives 1824 the first secured frame 1822. The receiver 1802 unsecures 1830 the first secured frame 1822. Further, the receiver 1802 unsecures the first secured frame 1822 by a nonce constructed based on a first BPN and a first PN.

Further, if the first secured frame 1822 includes a BPN field and a first PN field, the receiver 1802 may obtain the first BPN and the first PN directly. If the BPN field is not included, a default value (such as 0) may be used as the first BPN. The receiver 1802 may further construct the nonce for unsecuring the first secured frame 1822 based on the first BPN and the first PN. The receiver 1802 stores the first BPN locally.

The nonce constructed by the receiver 1802 should be the same as the first nonce used for securing the first secured frame constructed by the transmitter 1801. The first nonce constructed by the receiver 1802 is similar with that described above, i.e., constructed by the transmitter, and will not described in detail for ease of brevity.

In some example embodiments, the transmitter 1801 may further transmit a second secured frame to the receiver 1802, where the second secured frame includes a second PN but does not include a first BPN. The receiver 1802 may receive the second secured frame, and construct a second nonce based on the second PN and a locally stored first BPN, for unsecuring the second secured frame. In some examples, if the second PN is less than a PN in a previous secured frame, the receiver 1802 may determine that the PN has been wrap around, and thus the locally stored first BPN should be updated by incrementing by one.

In some other example embodiments, the transmitter 1801 may further transmit a third secured frame to the receiver 1802, where the third secured frame includes a second BPN and a third PN. The receiver 1802 may receive the third secured frame. Since the second BPN is different from the locally stored first BPN, the receiver 1802 may replace the first BPN by the second BPN. In other words, the second BPN is stored locally instead of the first BPN. The receiver 1802 further constructs a third nonce based on the second BPN and the third PN, for unsecuring the third secured frame.

In the present disclosure, a secured frame is generated by securing a compressed frame, where a compressed frame may be a compressed PSDU frame or a frame with a compressed header IE format being described above. The securing operation may be performed by using a cryptographic operation, such as an authentication or an encryption.

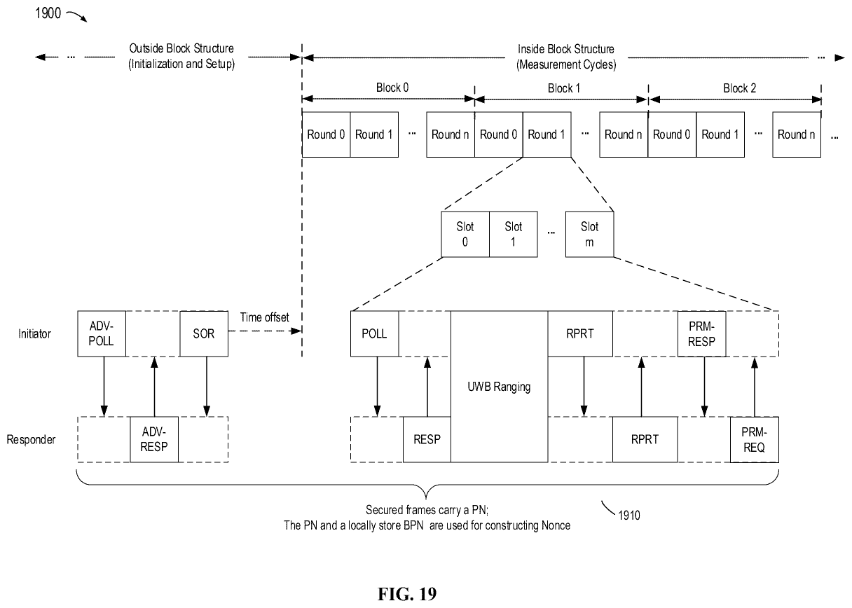

FIG. 19 illustrates a schematic diagram of an example MMS ranging session 1900 in accordance with some example embodiments of the present disclosure. As shown in FIG. 1900, the MMS ranging session 1900 includes an initialization and setup phase followed by one or more measurement cycles, where the initialization and setup phase is outside block structure, while the one or more measurement cycles are inside block structure.

In FIG. 19, a PN and a locally stored BPN can be used for constructing a nonce which is used for securing a frame, regardless of being outside or inside the block structure, as shown at 1910.

TABLE 4

| Responder ID | DL BPN | UL BPN |
|---|---|---|
| 1 | 0x00000078 | 0x00000048 |
| 2 | 0x00000294 | 0x000000159 |
| | . . . | |

TABLE 5

| Initiator ID | DL BPN | UL BPN |
|---|---|---|
| 1 | 0x00000078 | 0x00000048 |

TABLE 6

| Initiator ID | DL BPN | UL BPN |
|---|---|---|
| 1 | 0x00000294 | 0x000000159 |

Examples of locally stored BPN at an initiator (such as initiator 26) are shown in Table 4, while examples of locally stored BPN at responders (such as responder 270-1 and 270-2) are shown in Table 5 and Table 6 respectively. The DL BPN is used for secured frames transmitted by the initiator to the responder(s), while the UL BPN is used for secured frames transmitted by the responder(s) to the initiator.

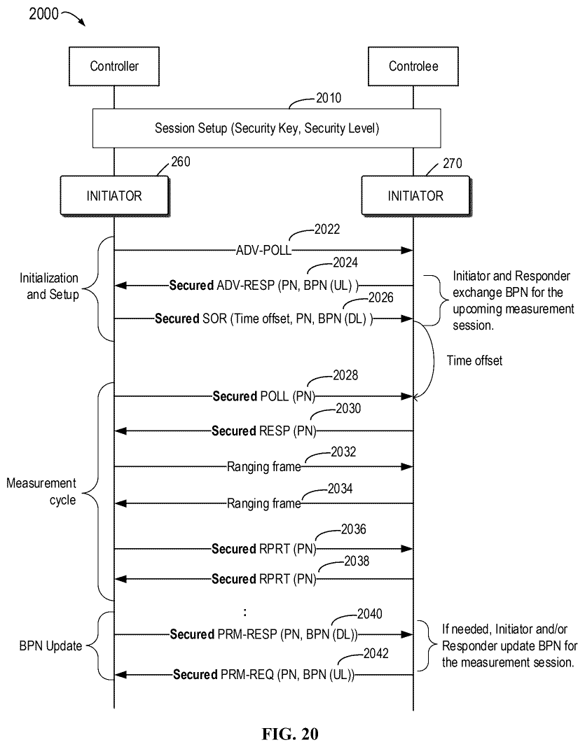

FIG. 20 illustrates a signalling chart illustrating a process 2000 of an example MMS ranging session in accordance with some example embodiments of the present disclosure.

Similar as some embodiments described above, the process 2000 begins with a controller and a controlee performing a session setup 2010. During the session setup 2010, the security key and the security level are assumed to be exchanged, long-term session parameters such as a UWB channel number, preamble codes, a block structure (such as number of blocks, block durations) etc. are negotiated. The long-term parameters are not expected to change during the MMS ranging session. When security is enabled, at least one security key will also be provided by the controller to each controlee to secure unicast frame (i.e., frames that are exchanged between the responder and the initiator). If security is enabled for broadcast frames as well, then a separate security key common to all responders are also provided. For an NBA-MMS ranging session, parameters related to narrow band (such as NB channel number, number of MMS fragments, etc.) may also be negotiated during the session setup 2010. Some other parameters such as number of MMS fragments, report mode etc. may be considered short term parameters since they may be modified during the MMS ranging session. The session setup 2010 may be performed out-of-band, for example using BLUETOOTH or Wi-Fi radio, or may also be performed in-band, for example using narrow band or UWB radio.

Additionally, the roles of initiator and responder are also assigned during the session setup 2010. As a specific example shown in FIG. 20, it is assumed that the controller takes the role of initiator 260 and the controlee is assigned the role of responder 270. However, it is to be understood that it is also possible that the controlee may be assigned the role of initiator while the controller assumes the role of responder.

At 2022, the initiator 260 transmits the ADV-POLL frames opportunistically at times and intervals to its discretion while the responder 270 may opportunistically listen for incoming ADV-POLL frames.

At 2024, the responder 270 responds with the ADV-RESP frame if the responder 270 intends to participate in a ranging session with the initiator 260. If security is enabled, the ADV-RESP frame carries a PN and a BPN associated with the uplink transmission, the PN and the BPN (UL) that are used to construct the nonce for securing the ADV-RESP frame. As shown in FIG. 20, a secured ADV-RESP frame may be transmitted from the responder 270 to the initiator 260.

Once the initiator 260 has received an ADV-RESP frame, it stores the BPN (UL) locally. At 2026, the initiator 260 transmits the SOR frame that provides a time offset at which the first range-measurement cycle will start. If security is enabled, the SOR frame carries a PN as well as a BPN associated with the downlink transmission, the PN and the BPN (DL) are used to construct the nonce used for securing the SOR frame. As shown in FIG. 20, a secured SOR frame may be transmitted from the initiator 260 to the responder 270. Once the responder 270 has received an SOR frame, it stores the BPN (DL) locally. It is to be noted that different number spaces may be used for the PN in the uplink (responder to initiator) and downlink (initiator to responder) directions.

At 2028, the initiator 260 transmits a POLL frame to the responder 270 at the beginning of the first slot of a round, where the beginning of the first slot is indicated by the time offset in the SOR frame. The initiator 260 may also include other control information in the POLL frame for the responder 270. At 2030, the responder 270 transmits a RESP frame back to the initiator 260 in case it receives the POLL frame successfully. The POLL and RESP frames allow the initiator 260 and responder 270 to achieve a time and frequency synchronization.

In the ranging phase, the initiator 260 and the responder 270 may exchange zero or more UWB RSFs and optionally one or more UWB RIFs. The RSFs are used to perform ranging measurements while the RIFs are used to check the integrity of the ranging measurements. Illustratively, the exchanging is shown at 2032 and 2034 in FIG. 20.

After the initiator 260 or the responder 270 completes the reception of all UWB fragments for the ranging phase, a report phase may start. During the report phase, the initiator 260 or the responder 270 may generate a ranging measurement report, and send an RPRT frame carrying the measurement report to the peer device. As shown in FIG. 20, the initiator 260 sends a secured RPRT frame to the responder 270 at 2036, while the responder 270 sends a secured RPRT frame to the initiator 260 at 2038.

Each of the secured POLL frame, the secured RESP frame, and secured RPRT frame carries a PN, the carried PN and a locally stored BPN may be used to construct the nonce for securing/unsecuring the POLL, RESP, and RPRT frames.

Additionally, as shown in FIG. 20, a PRM-RESP frame and a PRM-REQ frame may be exchanged between the initiator 260 and the responder 270. The initiator 260 may send a secured PRM-RESP frame including a new BPN, i.e., a new BPN (DL). The responder 270 may send a secured PRM-REQ frame including a new BPN, i.e., a new BPN (UL). Accordingly, the BPN saved locally can be updated.

Some example formats of frames and nonce are shown in the present disclosure with reference to drawing. However, it should be noted that the examples are given for the purpose of illustration without suggesting any limitations to the present disclosure. For example, a frame or nonce may include multiple fields, one or more fields may be omitted in some cases, one or more un-shown fields may further included. For example, two or more fields may be combined as one field. For example, one field may be replaced by one or more different fields. For example, a field carrying information may be split into two fields, one field carrying the information and the other one field being reserved. For example, each length (in unit of octets or bits) may be a fixed value or an adjusted value. For example, an arrangement of the fields may be in another way, e.g., in a different order. The present disclosure does not limit this aspect.

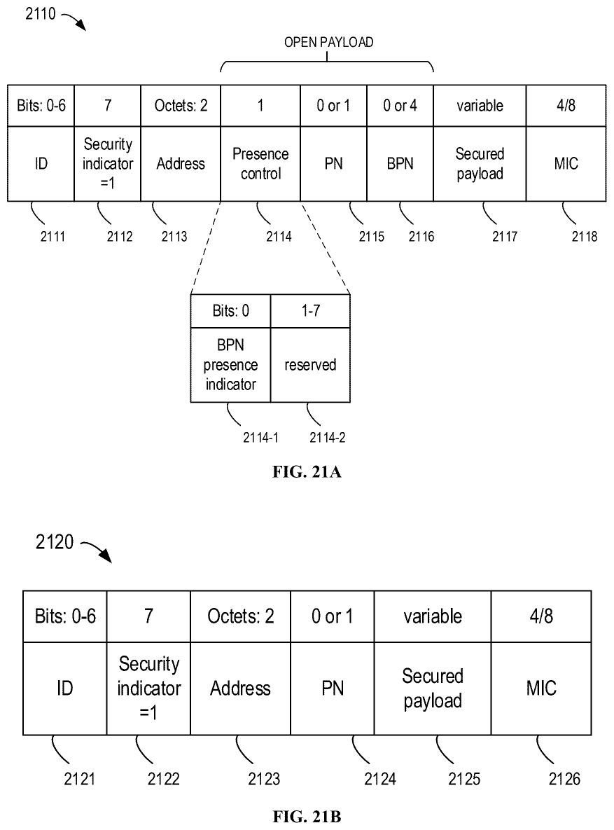

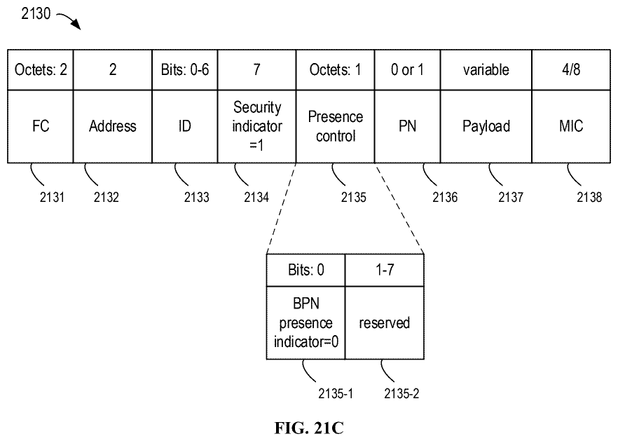

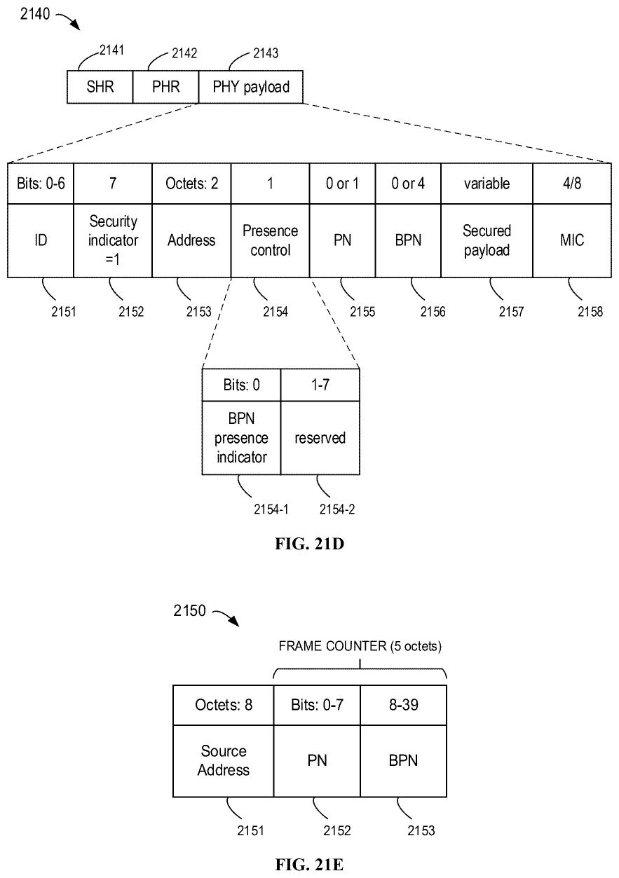

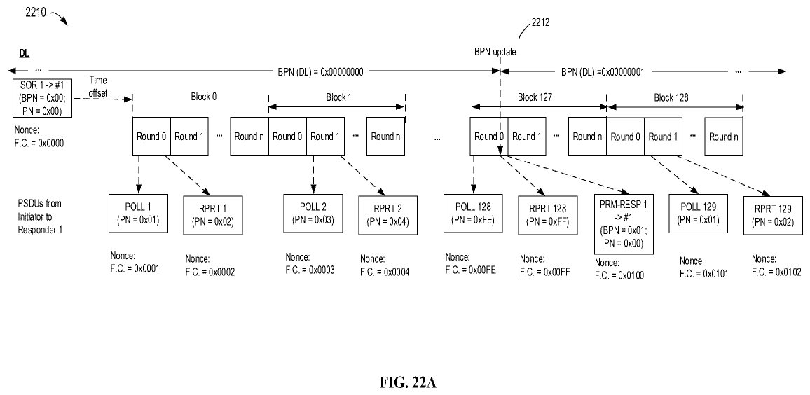

FIG. 21A illustrates a schematic diagram of a format of a secured frame 2110 during an initialization and setup phase in accordance with some example embodiments of the present disclosure. For example, the secured frame 2110 may be a secured ADV-RESP frame transmitted at 2024 or a secured SOR frame transmitted at 2026 in FIG. 20. The secured frame 2110 may be based on a compressed PSDU or it may be based on a compressed header ID format or even a 802.15.4 frame format, in which case the security enabled field in the frame control (FC) field is set to one to indicate that the auxiliary security header field is not present in the MHR.

As shown in FIG. 21A, the secured frame 2110 includes a field 2111 carrying an ID, a field 2112 carrying a security indicator, a field 2113 carrying an address, a field 2114 which is a presence control field including a field 2114-1 carrying a BPN presence indicator and a reserved field 2114-2, a field 2115 carrying a PN, a field 2116 carrying a BPN, a field 2117 carrying secured payload, and a field 2118 carrying the MIC.

The field 2112 may indicate whether the frame is secured. In some examples, the field 2112 may carry “1” indicating that it is secured. In some other examples, the field 2112 may carry “0” indicating that it is unsecured, for example, the field 2115 may not be included.

The fields 2114-2116 may be considered as open payload of the secured frame 2110. The open payload may be authenticated but not encrypted, since the BPN and the PN are used by the receiver to construct a nonce.

In case the secured frame 2110 is the secured ADV-RESP frame, the field 2116 may include a BPN associated with the uplink transmission, i.e., BPN_UL. In case the secured frame 2110 is the secured SOR frame, the field 2116 may include a BPN associated with the downlink transmission, i.e., BPN_DL. If the secured SOR frame is broadcasted or multicasted, then multiple BPN associated with multiple responders may be included in the open payload. In this case, the PN may also be drawn from a separate broadcast PN space.

In some examples, the secured frame 2110 may include a field carrying a security level, for example, if the security level is not negotiated during the session setup 2010.

FIG. 21B illustrates a schematic diagram of a format of a secured frame 2120 during a measurement cycle in accordance with some example embodiments of the present disclosure. For example, the secured frame 2120 may be a secured POLL frame transmitted at 2028, a secured RESP frame transmitted at 2030, or a secured RPRT frame transmitted at 2036/2038 in FIG. 20. The secured frame 2120 may be based on a compressed PSDU.

As shown in FIG. 21B, the secured frame 2120 includes a field 2121 carrying an ID, a field 2122 carrying a security indicator (e.g., “1” in FIG. 21B), a field 2123 carrying an address, a field 2124 carrying a PN, a field 2125 carrying secured payload, and a field 2126 carrying the MIC.

In some examples, the secured frame 2120 is similar with the secured RPRT frame 1610 described above, thus will not be described in detail for brevity.

FIG. 21C illustrates a schematic diagram of a format of a secured SOR frame 2130 in accordance with some example embodiments of the present disclosure. For example, the secured frame 2130 may be based on a frame with a compressed header IE format, i.e., a compressed header IE based format.

As shown in FIG. 21C, the secured SOR frame 2130 includes a field 2131 carrying an FC, a field 2132 carrying an address, a field 2133 carrying an ID, a field 2134 carrying a security indicator (e.g., “1” in FIG. 21C), a field which is a presence control field including a field 2135-1 carrying a BPN presence indicator and a reserved field 2135-2, a field 2136 carrying a PN, a field 2137 carrying a payload, and a field 2138 carrying the MIC. It is to be understood since the BPN presence indicator is “0” in field 2135-1, thus there is no field carrying BPN. The security enabled field in the frame control (FC) field 2131 is set to one to indicate that the auxiliary security header field is not present in the MHR. In this case, the secured SOR frame 2130 does not include a BPN field and the security level applied only involves authentication (i.e., the security level is any of 1, 2, or 3), thus the payload in field 2137 is not secured but the field 2138 carrying the MIC is included.

It is to be noted that in case a field with a length of k bits carrying the PN, a maximum of 2^{k} compressed frames can be secured before the BPN needs to be incremented. For example, if k=8 bits, maximum 256 frames can be secured for a same BPN.

In some examples, the locally stored BPN shall be incremented by 1 when the PN of a secured frame received from a transmitter is less than the PN for a previous secured frame received from the same transmitter. In some other examples, the BPN may be explicitly updated during a measurement session. For example, a secured PRM-REQ (for UL) or a secured PRM-RESP (for DL) may be used for updating the BPN.

FIG. 21D illustrates a schematic diagram of a format of a secured PRM-REQ or PRM-RESP frame 2140 in accordance with some example embodiments of the present disclosure. The secured frame 2140 includes an SHR field 2141, a PHR field 2142, and a PHY payload field 2143.

The field 2143 includes a field 2151 carrying an ID, a field 2152 carrying a security indicator (e.g., “1” in FIG. 21D), a field 2153 carrying an address, a field 2154 which is a presence control field including a field 2154-1 carrying a BPN presence indicator and a reserved field 2154-2, a field 2155 carrying a PN, a field 2156 carrying a BPN, a field 2157 carrying secured payload, and a field 2158 carrying the MIC.

The fields 2154-2156 may be considered as open payload of the secured frame 2140. The open payload may be authenticated but not encrypted, since the BPN and the PN are used by the receiver to construct a nonce.

In some examples, the field 2143 in the secured frame 2140 is similar with the secured frame 2110 described above, thus will not be described in detail for brevity.

FIG. 21E illustrates a schematic diagram of a format of a nonce 2150 in accordance with some example embodiments of the present disclosure. The nonce 2150 may be used for securing a frame or for unsecuring a secured frame, e.g., during the process 2000.

As shown in FIG. 21E, the nonce 2150 includes a frame 2151 carrying a source address, a field 2152 carrying a PN, and a field 2153 carrying a BPN. In some examples, the fields 2152-2153 may be considered as a frame counter of the nonce 2150. As shown in FIG. 21E, each length of the fields 2152-2153 is predefined, and a total quantity of the lengths is 40 bits.

Alternatively, the nonce 720 may include a field carrying a security level. Alternatively, the field 2153 may be split into two fields, one of which carrying the BPN and the other one being reserved. Alternatively, the field 2152 may be located after the field 2153, in other words, the order of fields 2152 and 2153 may be inversed.

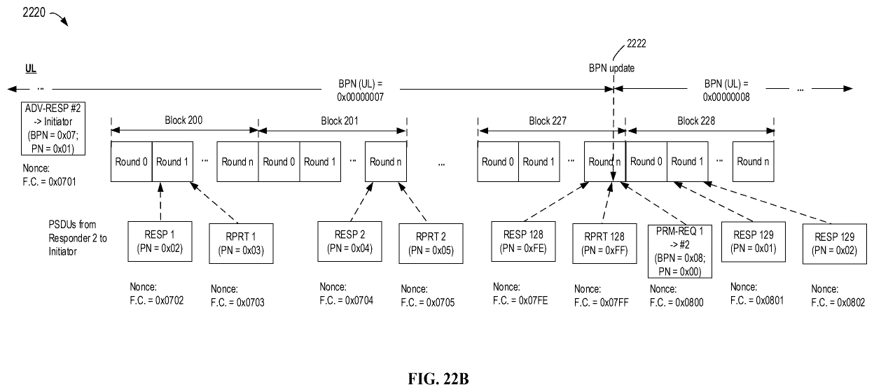

FIG. 22A illustrates an example downlink session 2210 from the initiator to a responder 1 (such as the responder 270-1) in accordance with some example embodiments of the present disclosure. The value (i.e., FC) in the frame counter field used to construct the nonce for securing/unsecuring each frame is shown below the frame.

As shown in FIG. 22A, the SOR frame may be a secured SOR frame as shown in FIG. 21A, and carries a BPN=0x00 and a PN=0x00. Accordingly, the first POLL frame (POLL 1) to responder 1 is transmitted in round 0 of block 0 and carries a PN field set to 0x01 and the least significant two octets (in hexadecimal) of the frame counter field used to construct the nonce for securing/unsecuring the POLL 1 frame can be calculated to be 0x0001. Similarly, the 128th RPRT frame (RPRT 128) is transmitted in round 0 of block 127 carrying a PN=0xFF and the least significant two octets (in hexadecimal) of the frame counter field used to construct the nonce for securing/unsecuring the RPRT 128 frame can be calculated to be 0x00FF. As shown in FIG. 22A, the BPN associated with the downlink transmission from the initiator to the responder 1 may be explicitly updated at 2212 by the initiator by transmitting a PRM-RESP 1 frame carrying a BPN field set to 0x01.

FIG. 22B illustrates an example uplink session 2220 from a responder 2 (such as the responder 270-2) to the initiator in accordance with some example embodiments of the present disclosure. The value (i.e., FC) in the frame counter field used to construct the nonce for securing/unsecuring each frame is shown below the frame.

As shown in FIG. 22B, the ADV-RESP frame may be a secured frame carried by the responder 2 and carries a BPN=0x07 and a PN=0x01. Accordingly, the first RESP frame (RESP 1) by responder 2 is transmitted in round 1 of block 20 and carries a PN field set to 0x02 and the least significant two octets (in hexadecimal) of the frame counter field used to construct the nonce for securing/unsecuring the RESP 1 frame can be calculated to be 0x0702. Similarly, the 128th RPRT frame (RPRT 128) is transmitted by responder 2 in round n of block 227 carrying a PN=0xFF and the least significant two octets (in hexadecimal) of the frame counter field used to construct the nonce for securing/unsecuring the RPRT 128 frame can be calculated to be 0x07FF. As shown in FIG. 22B, the BPN associated with the uplink transmission from the responder 2 to the initiator may be explicitly updated at 2222 by the responder 2 by transmitter a PRM-REQ 1 frame carrying a BPN field set to 0x08.

Alternatively, it is also possible to achieve the same effect for the construction of the Frame Counter field of the Nonce in FIG. 21E without segmenting the Frame Counter field into PN and BPN fields by defining the value (i.e., FC) of the frame counter field as Equation (7):

$$FC = PN \vert \vert BPN \qquad ( 7 )$$

In Equation (7), “|” represents a concatenation operation.

According to some embodiments with reference to FIGS. 18-22B, a BPN and a PN may be used for constructing a nonce, where the nonce may be used to securing a frame or unsecuring a secured frame, regardless whether the secured frame is transmitted based on a block-based time structure or a hyper block-based time structure, as such, an AEAD security operation may be applied and the security communication between an initiator and a responder can be guaranteed.

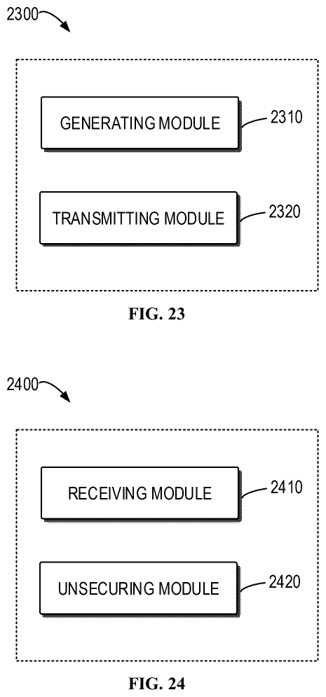

FIG. 23 illustrates an example block diagram of a communication apparatus 2300 in accordance with some embodiments of the present disclosure. The apparatus 2300 may be implemented at a transmitter, such as the transmitter 301 in FIG. 3 or the transmitter 1801 in FIG. 18, or be implemented as a chip or chip system within the transmitter. As shown in FIG. 23, the apparatus includes a generating module 2310 and a transmitting module 2320.

It is to be understood that the module may be referred to as a unit or means, and the present disclosure does not limit this aspect.

In some example embodiments, the generating module 2310 may be configured to generate a first secured frame to be transmitted in a slot in a first round belonging to a first block based on a block-based time structure or a hyper block-based time structure, wherein the block-based time structure or the hyper block-based time structure comprises a plurality of blocks, each block of the plurality of blocks comprises a plurality of rounds, each round of the plurality of rounds comprises a plurality of slots, wherein the first secured frame is secured by a first nonce being constructed based on identifying information associated with the first secured frame, a round index and a block index, the round index is an index of the first round, and the block index is an index of the first block. The transmitting module 2320 may be configured to transmit the first secured frame.

In some examples, the identifying information comprises a slot index, the slot index is an index of the slot which the first secured frame is transmitted in. In some examples, the first nonce comprises a first field with a first quantity of bits carrying the slot index.

In some examples, the first quantity is determined based on a quantity of the plurality of slots in each round, or the first quantity is a first predefined quantity.

In some examples, the identifying information comprises a first PN, and wherein the first PN is a packet number of the first secured frame. In some examples, the first nonce comprises a first field with a first quantity of bits carrying the first PN.

In some examples, the first quantity is a first predefined quantity.

In some examples, the first nonce comprises a second field with a second quantity of bits carrying the round index, and a third field with a third quantity of bits carrying the block index.

In some examples, the second quantity is determined based on a quantity of the plurality of rounds in each block, or the second quantity is a second predefined quantity. In some examples, the third quantity is a third predefined quantity.

In some examples, a sum of the first quantity, the second quantity, and the third quantity equals to a predefined total quantity.

In some examples, the first nonce comprises a fourth field with a fourth quantity of bits carrying a cycle index, wherein the cycle index is an index of a cycle which comprises a plurality of blocks with the first block in.

In some examples, the first nonce comprises a first block indicator indicating that the first secured frame is transmitted based on the block-based time structure or the hyper block-based time structure.

In some examples, the first secured frame comprises the block index and the round index. In some examples, the first secured frame comprises a first block index presence indicator indicating a presence of the first block index, and a first round index presence indicator indicating a presence of the first round index.

In some examples, the first secured frame comprises a first security indicator indicating that the first secured frame is secured.

In some examples, the generating module 2310 may be further configured to generate a second secured frame to be transmitted, wherein the second secured frame is secured by a second nonce being constructed based on a second PN, wherein the second PN is a packet number of the second secured frame. The transmitting module 2320 may be further configured to transmit the second secured frame.

In some examples, the second nonce comprises a field with a predefined quantity of octets carrying the second PN.

In some examples, the second nonce comprises a second block indicator indicating that the second secured frame is transmitted outside the block-based time structure or the hyper block-based time structure.

In some examples, the second secured frame comprises a PN field carrying the second PN.

In some examples, the second secured frame comprises a second security indicator indicating that the second secured frame is secured.

In some examples, the second secured frame comprises a secured payload, and wherein the secured payload comprises a second block index presence indicator indicating whether a second block index is comprised, a second round index presence indicator indicating whether a second round index is comprised, and a second slot index presence indicator indicating whether a second slot index is comprised.

In some examples, the secured payload comprises the block index if the second block index presence indicator indicates that the second block index is comprised, the round index if the second round index presence indicator indicates that the second round index is comprised, and the slot index if the second slot index presence indicator indicates that the second slot index is comprised.

In some examples, at least one of the second block index presence indicator, the second round index presence indicator, or the second slot index presence indicator indicates that a corresponding index is not comprised, and implicitly indicates that the corresponding index is a default index.

The apparatus 2300 can be used to implement some embodiments at a transmitter described with reference to FIGS. 3-17.

In some other example embodiments, the generating module 2310 may be configured to generate a first secured frame to be transmitted in a block-based time structure or a hyper block-based time structure, wherein the first secured frame is secured by a first nonce being constructed based on a first BPN and a first PN, the first BPN is associated with an initiator and a responder, and the first PN is a packet number of the first secured frame. The transmitting module 2320 may be configured to transmit the first secured frame.

In some examples, the first secured frame comprises a first security indicator indicating that the first secured frame is secured.

In some examples, the first nonce comprises a first field with a first quantity of bits carrying the first BPN, and a second field with a second quantity of bits carrying the first PN.

In some examples, the first secured frame comprises a first PN field carrying the first PN. In some examples, the first secured frame indicates the first BPN.

In some examples, the first secured frame comprises a BPN presence field carrying a BPN presence indicator indicating whether a BPN field is comprised.

In some examples, the first secured frame comprises the BPN field carrying the first BPN if the BPN presence indicator indicates that the BPN field is comprised.

In some examples, the first secured frame indicates that the first BPN is a default number if the BPN presence indicator indicates that the BPN field is not comprised.

In some examples, the apparatus 2300 may further comprise a storing module configured to store the first BPN associated with a first communication direction between the initiator and the responder.

In some examples, the transmitting module 2320 may be configured to transmit a second secured frame comprising a second PN which is less than a PN comprised in a previous frame of the third secured frame.

In some examples, the transmitting module 2320 may be configured to transmit a third secured frame comprising a second BPN.

The apparatus 2300 can be used to implement some embodiments at a transmitter described with reference to FIGS. 18-22B.

FIG. 24 illustrates an example block diagram of a communication apparatus 2400 in accordance with some embodiments of the present disclosure. The apparatus 2400 may be implemented at a receiver, such as the receiver 302 in FIG. 3 or the receiver 1802 in FIG. 18, or be implemented as a chip or chip system within the receiver. As shown in FIG. 24, the apparatus includes a receiving module 2410 and an unsecuring module 2420.

It is to be understood that the module may be referred to as a unit or means, and the present disclosure does not limit this aspect.

In some example embodiments, the receiving module 2410 may be configured to receive a first secured frame transmitted in a slot in a first round belonging to a first block based on a block-based time structure or a hyper block-based time structure, wherein the block-based time structure or the hyper block-based time structure comprises a plurality of blocks, each block of the plurality of blocks comprises a plurality of rounds, each round of the plurality of rounds comprises a plurality of slots. The unsecuring module 2420 may be configured to unsecure the first secured frame based on a first nonce, wherein the first nonce is constructed based on identifying information associated with the first secured frame, a round index and a block index, wherein the round index is an index of the first round, and the block index is an index of the first block.

In some examples, the identifying information comprises a slot index, the slot index is an index of the slot which the first secured frame is transmitted in. In some examples, the first nonce comprises a first field with a first quantity of bits carrying the slot index.

In some examples, the first quantity is determined based on a quantity of the plurality of slots in each round, or the first quantity is a first predefined quantity.

In some examples, the identifying information comprises a first PN, and wherein the first PN is a packet number of the first secured frame.

In some examples, the first nonce comprises a first field with a first quantity of bits carrying the first PN. In some examples, the first quantity is a first predefined quantity.

In some examples, the first nonce comprises a second field with a second quantity of bits carrying the round index, and a third field with a third quantity of bits carrying the block index.

In some examples, the second quantity is determined based on a quantity of the plurality of rounds in each block, or the second quantity is a second predefined quantity. In some examples, the third quantity is a third predefined quantity.

In some examples, a sum of the first quantity, the second quantity, and the third quantity equals to a predefined total quantity.

In some examples, the first nonce comprises a fourth field with a fourth quantity of bits carrying a cycle index, wherein the cycle index is an index of a cycle which comprises a plurality of blocks with the first block in.

In some examples, the first nonce comprises a first block indicator indicating that the first secured frame is in transmitted based on the block-based time structure or the hyper block-based time structure.

In some examples, the first secured frame comprises the block index and carrying the round index.

In some examples, the first secured frame comprises a first block index presence indicator indicating a presence of the first block index, and a first round index presence indicator indicating a presence of the first round index.

In some examples, the first secured frame comprises a first security indicator indicating that the first secured frame is secured.

In some examples, the receiving module 2410 may be further configured to receive a second secured frame transmitted not based on the block-based time structure or the hyper block-based time structure. The unsecuring module 2420 may be further configured to unsecure the second secured frame based on a second nonce being constructed based on a second PN, wherein the second PN is a packet number of the second secured frame.

In some examples, the second nonce comprises a field with a predefined quantity of octets carrying the second PN.

In some examples, the second nonce comprises a second block indicator indicating that the second frame is transmitted outside the block-based time structure or the hyper block-based time structure.

In some examples, the second secured frame comprises a PN field carrying the second PN.

In some examples, the second secured frame comprises a second security indicator indicating that the second secured frame is secured.

In some examples, the second secured frame comprises a secured payload, wherein unsecuring the second secured frame comprises unsecuring the secured payload based on the second nonce, and wherein the secured payload comprises a second block index presence indicator indicating whether a second block index is comprised, a second round index presence indicator indicating whether a second round index is comprised, and a second slot index presence indicator indicating whether a second slot index is comprised.

In some examples, the secured payload comprises the block index if the second block index presence indicator indicates that the second block index is comprised, the round index if the second round index presence indicator indicates that the second round index is comprised, and the slot index if the second slot index presence indicator indicates that the second slot index is comprised.

In some examples, the unsecuring module 2420 may be configured to: in accordance with a determination that at least one of the second block index presence indicator, the second round index presence indicator, or the second slot index presence indicator indicates that a corresponding index is not comprised, determine that the corresponding index is a default index.

The apparatus 2400 can be used to implement some embodiments at a receiver described with reference to FIGS. 3-17.

In some other example embodiments, the receiving module 2410 may be configured to receive a first secured frame transmitted in the block-based time structure or the hyper block-based time structure. The unsecuring module 2420 may be configured to unsecure the first secured frame based on a first nonce, wherein the first nonce is constructed based on a first BPN and a first PN, the first BPN is associated with an initiator and a responder, and the first PN is a packet number of the first secured frame.

In some examples, the first secured frame comprises a first security indicator indicating that the first secured frame is secured.

In some examples, the first nonce comprises a first field with a first quantity of bits carrying the first BPN, and a second field with a second quantity of bits carrying the first PN.

In some examples, the first secured frame comprises a first PN field carrying the first PN. In some examples, the first secured frame indicates the first BPN.

In some examples, the first secured frame comprises a BPN presence field carrying a BPN presence indicator indicating whether a BPN field is comprised.

In some examples, the first secured frame comprises the BPN field carrying the first BPN if the BPN presence indicator indicates that the BPN field is comprised.

In some examples, the first secured frame indicates that the first BPN is a default number if the BPN presence indicator indicates that the BPN field is not comprised.

In some examples, the apparatus 2400 may further comprise a storing module configured to store the first BPN associated with a first communication direction between the initiator and the responder.

In some examples, the receiving module 2410 may be further configured to receive a second secured frame comprising a second PN. The apparatus 2400 may further comprise an updating module configured to if the second PN is less than a PN comprised in a previous frame of the third secured frame, update the first BPN by incrementing by one.

In some examples, the receiving module 2410 may be further configured to receive a third secured frame comprising a second BPN. The apparatus 2400 may further comprise an updating module configured to replace the first BPN by the second BPN.

The apparatus 2400 can be used to implement some embodiments at a receiver described with reference to FIGS. 18-22B.

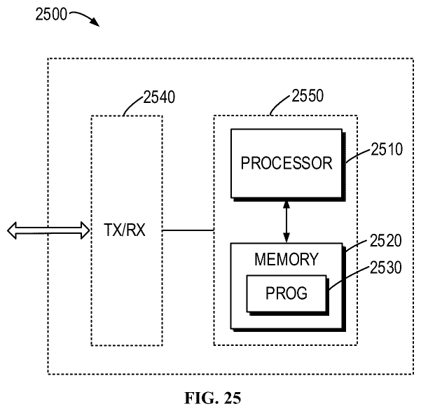

FIG. 25 illustrates an example block diagram of a device 2500 that may be used to implement some embodiments of the present disclosure. The device 2500 can be considered as a further example implementation (e.g., part) of the controller 210 and the controlee 220 as shown in FIG. 2A, or of the initiator 260 and the responder 270 as shown in FIG. 2B.

As shown, the device 2500 includes a processor 2510, a memory 2520 coupled to the processor 2510, a suitable transmitter (TX) and receiver (RX) 2540 coupled to the processor 2510, and a communication interface coupled to the TX/RX 2540. The memory 2510 stores at least a part of a program 2530. The TX/RX 2540 is for bidirectional communications. The TX/RX 2540 has at least one antenna to facilitate communication, though in practice an Access Node mentioned in this disclosure may have several ones. The communication interface may represent any interface that is necessary for communication with other network elements, such as X2 interface for bidirectional communications between evolved Node Bs (eNBs), SI interface for communication between a Mobility Management Entity (MME)/Serving Gateway (S-GW) and the eNB, Un interface for communication between the eNB and a relay node (RN), or Uu interface for communication between the eNB and a terminal device.

The program 2530 is assumed to include program instructions that, when executed by the associated processor 2510, enable the device 2500 to operate in accordance with the embodiments of the present disclosure, as discussed herein with reference to FIGS. 3-24. The embodiments herein may be implemented by computer software executable by the processor 2510 of the device 2500, or by hardware, or by a combination of software and hardware. The processor 2510 may be configured to implement various embodiments of the present disclosure. Furthermore, a combination of the processor 2510 and memory 2520 may form processing means 2550 adapted to implement various embodiments of the present disclosure.

The memory 2520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 2520 is shown in the device 2500, there may be several physically distinct memory modules in the device 2500. The processor 2510 may be of any type suitable to the local technical network, and may include one or more of general purpose computers, special purpose computers, microprocessors, digital signal processors (DSPs) and processors based on multicore processor architecture, as non-limiting examples. The device 2500 may have multiple processors, such as an application specific integrated circuit chip that is slaved in time to a clock which synchronizes the main processor.

The present disclosure provides a device comprising a processor and a memory storing computer program codes; the memory and the computer program codes configured to, with the processor, cause the device to perform the method implemented at the transmitter or the receiver discussed above.

The present disclosure provides a computer readable medium having instructions stored thereon, the instructions, when executed by a processor of an apparatus, causing the apparatus to perform the method implemented at the transmitter or the receiver discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3-24. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random-access memory (RAM), a read-only memory (ROM), an erasable programmable ROM (EPROM or Flash memory), an optical fiber, a portable compact disc (CD)-ROM, an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features or methodological acts, it is to be understood that the present disclosure defined in the appended claims is not necessarily limited to the specific features or acts described above. Rather, the specific features and acts described above are disclosed as example forms of implementing the claims.

1. A method comprising:
generating a first secured frame for transmission in a slot in a first round belonging to a first block based on a block-based time structure or a hyper block-based time structure, wherein the block-based time structure or the hyper block-based time structure comprises blocks, wherein each of the blocks comprises rounds, wherein each of the plurality of rounds comprises slots, wherein a first nonce secures the first secured frame and is based on identifying information associated with the first secured frame, a round index of the first round, and a block index of the first block; and
transmitting the first secured frame.

2. The method of claim 1, wherein the identifying information comprises a slot index of the slot in which the first secured frame is transmitted.

3. The method of claim 2, wherein the first nonce comprises a first field with a first quantity of bits carrying the slot index.

4. The method of claim 3, further comprising determining the first quantity based on a second quantity of the slots in each round, or setting the first quantity to a first predefined quantity.

5. The method of claim 1, wherein the identifying information comprises a first packet number (PN) of the first secured frame.

6. The method of claim 5, wherein the first nonce comprises a first field with a first quantity of bits carrying the first PN.

7. The method of claim 6, wherein the first quantity is a first predefined quantity.

8. The method of claim 1, wherein the first nonce comprises:
a second field with a second quantity of bits carrying the round index, and
a third field with a third quantity of bits carrying the block index.

9. The method of claim 8, further comprising determining the second quantity based on a fourth quantity of the rounds in each of the blocks, or setting the second quantity to a second predefined quantity.

10. The method of claim 8, wherein the third quantity is a third predefined quantity.

11. An apparatus comprising:
one or more processors configured to generate a first secured frame for transmission in a slot in a first round belonging to a first block based on a block-based time structure or a hyper block-based time structure, wherein the block-based time structure or the hyper block-based time structure comprises blocks, wherein each of the blocks comprises rounds, wherein each of the rounds comprises slots, wherein a first nonce secures the first secured frame and is based on identifying information associated with the first secured frame, a round index of the first round, and a block index of the first block; and
a transmitter configured to transmit the first secured frame.

12. The apparatus of claim 11, wherein the identifying information comprises a slot index of the slot in which the first secured frame is transmitted.

13. The apparatus of claim 12, wherein the first nonce comprises a first field with a first quantity of bits carrying the slot index.

14. The apparatus of claim 13, wherein the one or more processors are further configured to determine the first quantity based on a second quantity of the slots in each round, or set the first quantity to a first predefined quantity.

15. The apparatus of claim 11, wherein the identifying information comprises a first packet number (PN) of the first secured frame.

16. The apparatus of claim 15, wherein the first nonce comprises a first field with a first quantity of bits carrying the first PN.

17. The apparatus of claim 16, wherein the first quantity is a first predefined quantity.

18. The apparatus of claim 11, wherein the first nonce comprises:
a second field with a second quantity of bits carrying the round index, and
a third field with a third quantity of bits carrying the block index.

19. A computer program product comprising computer-executable instructions that are stored on a non-transitory computer storage medium and that, when executed by one or more processors, cause an apparatus to:
generate a first secured frame for transmission in a slot in a first round belonging to a first block based on a block-based time structure or a hyper block-based time structure, wherein the block-based time structure or the hyper block-based time structure comprises blocks, wherein each of the blocks comprises rounds, wherein each of the rounds comprises slots, wherein a first nonce secures the first secured frame and is based on identifying information associated with the first secured frame, a round index of the first round of the first block; and
transmit the first secured frame.

20. The computer program product of claim 19, wherein the identifying information comprises a slot index of the slot in which the first secured frame is transmitted.
